(19) United States
(12) Patent Application Publication
(10) Pub. No.: US 2019/0266523 A1
(43) Pub. Date: Aug. 29, 2019

(54) Resource Processing Method and Device

(71) Applicant: Alibaba Group Holding Limited, Grand Cayman (KY)

(72) Inventor: Lei DU, Zhejiang (CN)

(73) Assignee: Alibaba Group Holding Limited

(21) Appl. No.: 16/410,856

(22) Filed: May 13, 2019

Related U.S. Application Data
(63) Continuation of application No. PCT/CN2017/119676, filed on Dec. 29, 2017.

(30) Foreign Application Priority Data
Jan. 9, 2017 (CN) 201710013562.3

(51) Int. Cl. G06Q 10/02; G06F 16/9535; G06F 16/958; G06Q 20/10; G06Q 50/14

(52) U.S. Cl. CPC G06Q 10/025; G06F 16/9535; G06Q 50/14; G06Q 20/102; G06F 16/958

(57) ABSTRACT

A resource processing method, device, and system are provided. The method includes a resource provider being able to dynamically obtain resource(s) matching an itinerary event included in product information from a resource sharing server when publishing the product information, so that the resources required for the entire itinerary event are relatively complete. This thus effectively improves the efficiency of obtaining the resources corresponding to the itinerary event from the resource sharing server by a user, and improves the user experience about network services provided by the resource sharing server. Furthermore, these resources may come from other resource providers, thus ensuring the efficiency of promoting resources provided by the resource providers in the resource sharing server, and thereby improving the turnover rate of the resources.

### CROSS REFERENCE TO RELATED PATENT APPLICATIONS

This application claims priority to and is a continuation of PCT Patent Application No. PCT/CN2017/119676 filed on 29 Dec. 2017, and is related to and claims priority to Chinese Patent Application No. 201710013562.3, filed on 9 Jan. 2017 and entitled “Resource Processing Method and Device,” which are hereby incorporated by reference in their entirety.

### TECHNICAL FIELD

The present disclosure relates to Internet information processing and computer technological fields, and particularly to resource processing methods and devices.

### BACKGROUND

With the development of science and technology, a variety of Internet service platforms have emerged. These Internet service platforms can provide users with a variety of network services.

In practical applications, an Internet service platform can cooperate with different resource providers, so that the Internet service platform can provide users with different resources, such as clothing resources, home appliance resources, travel resources, ticket resources, etc.

A user can obtain desired resources from an Internet service platform through searching. At present, resources provided by an Internet service platform to users either are independent of each other or include some fixed combinations, for example, providing a combination of ticket resources and accommodation resources. However, the resources currently provided by the Internet service platform cannot meet the needs of the users. Specifically, when a user wants to travel to a certain place, the user not only needs to search for air ticket resources and accommodation resources from an Internet service platform, but also needs to search for travel resources and ticket resources of places of attractions that he/she wants to go from the Internet service platform. All the needed resources can be obtained only through multiple interactions with the Internet service platform, which leads to a relatively poor user experience of network services provided to the user by the Internet service platform.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

Accordingly, embodiments of the present disclosure provide a resource processing method and a device thereof for solving a problem of relative poor user experience of a resource set provided to a user by an Internet service platform in existing technologies.

The embodiments of the present disclosure provide a resource processing method, which is applied in a first resource provider, and includes:

sending a resource search request to a resource sharing server, the resource search request including at least one itinerary sub-event in a first itinerary event;

receiving response information sent from the resource sharing server, the response information including a first resource that is included in product information published by a second resource provider and required by the at least one itinerary sub-event, and determining a correspondence relationship between the first resource and the itinerary sub-event that requires the first resource; and

publishing product information including the correspondence relationship in the resource sharing server.

The embodiments of the present disclosure further provide a resource processing method, which includes:

receiving a resource search request sent by a first resource provider, the resource search request including an itinerary event;

finding at least one resource that satisfies requirements of an itinerary event from a shared resource library, the shared resource library including a plurality of resources that are provided by different resource providers and demarcated according to usage attributes of the resources, and the usage attributes of the resources being determined based on different sub-itinerary events included in the itinerary event; and

sending response information including the at least one resource that is found to the first resource provider.

The present disclosure further provides a resource processing device, which is applied in a server corresponding to a first resource provider, and includes:

a sending unit that sends a resource search request to a resource sharing server, the resource search request including at least one itinerary sub-event in a first itinerary event;

a receiving unit receives response information sent from the resource sharing server, the response information including a first resource that is included in product information published by a second resource provider and required by the at least one itinerary sub-event; and

a processing unit that determines a correspondence relationship between the first resource and the itinerary sub-event that requires the first resource, and publishes product information including the correspondence relationship in the resource sharing server.

The embodiments of the present disclosure further provide a resource processing device, which includes:

a receiving unit that receives a resource search request sent by a first resource provider, the resource search request including an itinerary event;

a searching unit that finds at least one resource that satisfies requirements of an itinerary event from a shared resource library, the shared resource library including a plurality of resources that are provided by different resource providers and demarcated according to usage attributes of the resources, and the usage attributes of the resources being determined based on different sub-itinerary events included in the itinerary event; and

a sending unit that sends response information including the at least one resource that is found to the first resource provider.

At least one technical solution that is adopted by the embodiments of the present disclosure as described above can achieve the following beneficial effects:

When publishing product information, a resource provider can dynamically obtain resource(s) matching an itinerary event included in the product information from a resource sharing server, so that the resources required for the entire itinerary event are relatively complete. This thus effectively improves the efficiency of obtaining the resources corresponding to the itinerary event from the resource sharing server by a user, and improves the user experience about network services provided by the resource sharing server. Furthermore, these resources may come from other resource providers, thus ensuring the efficiency of promoting resources provided by the resource providers in the resource sharing server, and thereby improving the turnover rate of the resources.

The embodiments of the present disclosure further provide a resource processing method, which is applied in a first resource provider, and includes:

determining a first itinerary event to be published;

determining itinerary sub-events included in the first itinerary event according to the first itinerary event, and matching corresponding resources for the itinerary sub-events;

generating product information to be published according to resources corresponding to different itinerary sub-events, the resources included in the product information being shared with a second itinerary event in response to satisfying a need of the second itinerary event published by a second resource provider; and

publishing the product information, the product information including the first itinerary event and a product resource set including product resources used by the first itinerary event.

The embodiments of the present disclosure further provide a resource processing device, which is applied in a server corresponding to a first resource provider, and includes:

a determination unit that determines a first itinerary event to be published; and determines itinerary sub-events included in the first itinerary event according to the first itinerary event, and matches corresponding resources for the itinerary sub-events;

a generation unit that generates product information to be published according to resources corresponding to different itinerary sub-events, the resources included in the product information being shared with a second itinerary event in response to satisfying a need of the second itinerary event published by a second resource provider; and

a publishing unit that publishes the product information, the product information including the first itinerary event and a product resource set including product resources used by the first itinerary event.

The embodiments of the present disclosure further provide a resource processing method, which includes:

receiving pieces of product information sent by different resource providers, the pieces of product information including itinerary events and at least one resource used by an itinerary sub-event in the itinerary events;

combining, for a same itinerary event, different types of resources used by same/different itinerary sub-events in different pieces of product information including the itinerary event to obtain a resource set used by the itinerary event; and

publishing the itinerary event and the resource set.

The embodiments of the present disclosure further provide a resource processing device, which includes:

a receiving unit that receives pieces of product information sent by different resource providers, the pieces of product information including itinerary events and at least one resource used by an itinerary sub-event in the itinerary events;

a combination unit that combines, for a same itinerary event, different types of resources used by same/different itinerary sub-events in different pieces of product information including the itinerary event to obtain a resource set used by the itinerary event; and

a publishing unit that publishes the itinerary event and the resource set.

At least one technical solution that is adopted by the embodiments of the present disclosure as described above can achieve the following beneficial effects:

In the technical solutions provided by the embodiments of the present disclosure, a resource provider performs a refinement on resources according to a degree of granularity of itinerary sub-events, so that a resource sharing server can combine resources included in product information when receiving the product information published by different resource providers. This ensures that a user can clearly understand various types of resources included in a resource set when obtaining the resource set. As such, personalization and refinement of network services provided by the resource sharing server are improved, and the user experience about the network services is improved, effectively changing the turnover efficiency of resources provided by the resource sharing server.

The embodiments of the present disclosure further provide a resource processing method, which includes:

receiving a search request sent by a user, the search request including an itinerary event to be searched for;

determining product information including the itinerary event according to the itinerary event, the product information including a correspondence relationship between resource(s) used by itinerary sub-event(s) in the itinerary event and the itinerary sub-event(s); and

pushing the product information to the user.

The embodiments of the present disclosure further provide a resource processing device, which includes:

a receiving unit that receives a search request sent by a user, the search request including an itinerary event to be searched for;

a determination unit that determines product information including the itinerary event according to the itinerary event, the product information including a correspondence relationship between resource(s) used by itinerary sub-event(s) in the itinerary event and the itinerary sub-event(s); and

a sending unit that pushes the product information to the user.

At least one technical solution that is adopted by the embodiments of the present disclosure as described above can achieve the following beneficial effects:

In the technical solutions provided by the embodiments of the present disclosure, when receiving a search request sent by a user, a resource sharing server can push resources that are refined according to a degree of granularity of itinerary sub-events to the user. This not only makes resources needed by an entire itinerary event to be relatively complete, but also effectively improves the efficiency of obtaining the resources corresponding to the itinerary event from the resource sharing server by the user. This thereby improves the user experience about network services provided by the resource sharing server, and improves the personalization and refinement of the network services provided by the resource sharing server, thus effectively changing the turnover efficiency of the resources provided by the resource sharing server.

### BRIEF DESCRIPTION OF THE DRAWINGS

The drawings described herein are intended to provide a further understanding of the present disclosure, and are intended to be a part of the present disclosure. Illustrative embodiments and a description thereof are intended to describe the present disclosure, and are not to be construed as improper limitations of the present disclosure. In the drawing:

FIG. 1 is a schematic flowchart diagram of a resource processing method according to an embodiment of the present disclosure.

FIG. 2 is a schematic diagram of product information published by a resource party according to an embodiment of the present disclosure.

FIG. 3 is a schematic flowchart of a resource processing method according to an embodiment of the present disclosure.

FIG. 4 is a schematic flowchart diagram of a resource processing method according to an embodiment of the present disclosure.

FIG. 5 is a schematic flowchart diagram of a resource processing method according to an embodiment of the present disclosure.

FIG. 6 is a schematic diagram of a resource set provided by an embodiment of the present disclosure.

FIG. 7 is a schematic diagram of a resource payment scenario provided by an embodiment of the present disclosure.

FIG. 8 is a schematic flowchart diagram of a resource processing method according to an embodiment of the present disclosure.

FIG. 9 is a schematic structural diagram of a resource processing device according to an embodiment of the present disclosure.

FIG. 10 is a schematic structural diagram of a resource processing device according to an embodiment of the present disclosure.

FIG. 11 is a schematic structural diagram of a resource processing device according to an embodiment of the present disclosure.

FIG. 12 is a schematic structural diagram of a resource processing device according to an embodiment of the present disclosure.

FIG. 13 is a schematic structural diagram of a resource processing device according to an embodiment of the present disclosure.

FIG. 14 is a schematic structural diagram of a resource processing system according to an embodiment of the present disclosure.

FIG. 15 is a schematic diagram of the resource processing device as shown in FIGS. 9-13 in further detail.

### DETAILED DESCRIPTION

With the improvement of living standards, “going on an itinerary at any time” has become fashionable. However, how to properly arrange your travel itinerary has become an important issue. In practical applications, an arrangement of a travel itinerary generally requires a user to schedule according to time, for example, booking an air ticket or a train ticket via the Internet, booking a hotel through the Internet, and arranging trips to watch places of attractions through the Internet. However, if the schedule is unreasonable, the travel experience of the user will be affected, or some predetermined content cannot be achieved if the time is not well planned, making the travel experience of the user to become relatively poor.

As an Internet service platform that provides users with network services, a “travel package” is proposed, which provides the users with “hotel+place of attraction” or “air ticket+hotel” network services. This type of “travel package” includes corresponding travel services, such as “hotel+place of attraction” to make arrangements of accommodation and sightseeing places of attractions for users' travel. “Air ticket+hotel” provides users with air tickets and accommodation arrangements. However, since this type of combination is a manner of tight coupling, users are not very satisfied with this type of network service. Furthermore, a suspicion that the Internet service platform implements bundled sales also exists, thereby reducing the service quality of the Internet service platform.

Based on the above situations, the embodiments of the present disclosure provide a dynamic and flexible itinerary arrangement method to improve the freedom of travel itineraries of users.

In order to achieve the purposes of the present disclosure, the embodiments of the present disclosure provide a resource processing method and a device thereof. When publishing product information, a resource provider can dynamically obtain resources matching an itinerary event included in the product information from a resource sharing server, so that the resources required for the entire itinerary event are relatively complete. This thus effectively improves the efficiency of obtaining the resources corresponding to the itinerary event from the resource sharing server by a user, and improves the user experience about network services provided by the resource sharing server. Furthermore, these resources may come from other resource providers, thus ensuring the efficiency of promoting resources provided by the resource providers in the resource sharing server, and thereby improving the turnover rate of the resources.

It should be noted that usage attributes of resources described in the embodiments of the present disclosure may include, but are not limited to, traffic attributes, accommodation attributes, visiting attributes, warming attributes, anti-slipping attributes, etc. Different resources have different corresponding use attributes. Specific content of the usages attributes may be determined based on actual needs, or may be determined according to the usability of the resources themselves, which are not limited herein.

Attribute values of the usage attributes described in the embodiments of the present disclosure can be understood as attribute values corresponding to different usage attributes. The ways of expression as different as the sizes of the attribute values are different. For example, attribute values corresponding to a traffic attribute can be understood as a departure time and an arrival time. Attribute values corresponding to an accommodation attribute can be understood as a check-in time and a check-out time. A visiting attribute can be understood as an opening time of a place of attraction, etc.

The resources described in the embodiments of the present disclosure may be an air ticket, a train ticket, a night stay, etc., which are not specifically limited herein.

In order to make the purposes, technical solutions and advantages of the present disclosure to be clearer, the technical solutions of the present disclosure will be clearly and completely described hereinafter with reference to specific embodiments and corresponding drawings of the present disclosure. Apparently, the described embodiments represent merely a part and not all of the embodiments of the present disclosure. All other embodiments obtained by one of ordinary skill in the art based on the embodiments of the present disclosure without making any inventive effort fall within the scope of protection of the present disclosure.

The technical solutions provided by the embodiments of the present disclosure are described in detail hereinafter with reference to the accompanying drawings.

### First Embodiment

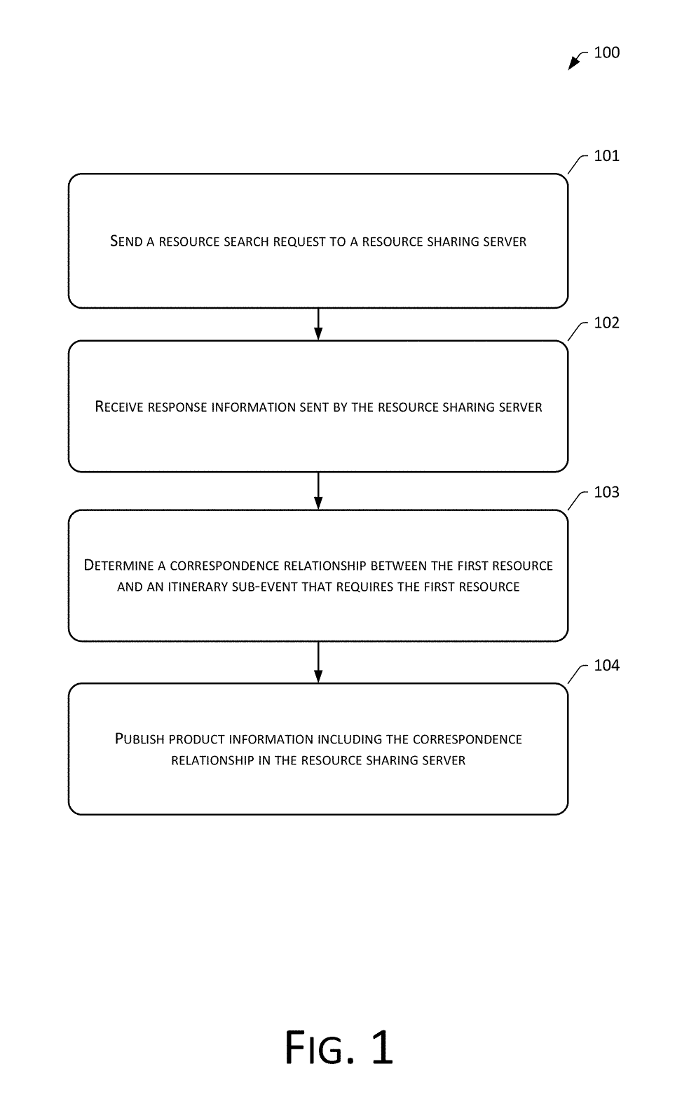

FIG. 1 is a schematic flowchart diagram of a resource processing method 100 according to an embodiment of the present disclosure. The method 100 is described hereinafter. An execution entity of the embodiment of the present disclosure is a client or a server of a first resource provider.

In the embodiments of the present disclosure, before publishing product information, a resource provider may obtain required resources from a product sharing resource server, and thereby obtain resources required for an itinerary event included in the product information to be published. As such, the resource provider can publish complete and reasonable product information to meet different needs of users.

It should be emphasized that resources used in product information published by a resource provider described in the embodiments of the present disclosure can be shared with resources used in product information published by other resource providers, so that dynamicity and flexibility of the resources contained in the product information can also be guaranteed.

Operation 101: Send a resource search request to a resource sharing server.

The resource search request includes at least one itinerary sub-event in a first itinerary event.

In the embodiments of the present disclosure, the resource search request sent by the resource provider to the resource sharing server sending may be demarcated into, but is not limited to, the following two situations:

A first situation: The resource provider has a portion of resources used by the itinerary event.

Specifically, the resource provider first determines product information to be published.

The product information includes the first itinerary event and a second resource used by the at least one itinerary sub-event in the first itinerary event.

In the embodiments of the present disclosure, product information includes not only an itinerary event but also resources used by each itinerary sub-event in the itinerary event.

The so-called itinerary event can be understood as a trip. This trip can contain multiple places, or can contain a place, which is not limited herein. The number of days consumed in a trip described in the embodiments of the present disclosure is not limited.

Nevertheless, in the embodiments of the present disclosure, the itinerary event may be divided into a plurality of itinerary sub-events in units of days.

An example is a Hong Kong trip from 12.23 to 12.26, and a four-day Hong Kong trip can be taken as an itinerary event. This itinerary event includes four itinerary sub-events, i.e., going from a certain place to Hong Kong on 12.23 can be taken as an itinerary sub-event. Two days (12.24 and 12.25) in Hong Kong can be taken as two itinerary sub-events. Returning to a place of departure from Hong Kong on 12.26 can be taken as an itinerary sub-event.

Different itinerary sub-events use different resources. For example, resources used in such itinerary sub-event of going to Hong Kong on 12.23 mat be a ticket resource and a hotel resource. Resources used in such itinerary sub-event of one day (12.24) in Hong Kong may be a Disneyland Park ticket resource and a hotel resource. A resource used in such itinerary sub-event of one day (12.25) in Hong Kong may be a hotel resource. A resource used in such itinerary sub-event of returning to a place of departure from Hong Kong may be a ticket resource.

As a resource provider, it is possible to cooperate with different resource providers offline. When the product information is published, some resources used by the itinerary event have been obtained from different resource providers, and these resources may be referred to as resources owned by the resource provider.

For example, the resource provider is a travel agency. When posting “4-day Hong Kong travel” product information, resources of an itinerary event included in this product information that have been determined to be possessed are as shown in Table 1:

TABLE 1

| Itinerary event | Resources |
|---|---|
| Itinerary sub-event 1: From A to Hong | Air ticket resource and |
| Kong on 12.23 | hotel resource |
| Itinerary sub-event 2: Travel in Hong Kong | Null |
| on 12.24 | |
| Itinerary sub-event 3: Travel in Hong Kong | Null |
| on 12.25 | |
| Itinerary sub-event 5: From Hong Kong to | Air ticket resource |
| A on 12.26 | |

As can be seen from Table 1, resources possessed by the resource provider for this itinerary event are: an air ticket resource for flights from A to Hong Kong on 12.23 and a hotel resource on the first night after arriving in Hong Kong; and 12.26 an air ticket resource for flights from Hong Kong to A.

Secondly, the resource provider determines itinerary sub-events with missing resources in the first itinerary event according to the second resources.

Specifically, based on usage attributes of the second resources owned by the resource provider, a second resource satisfying a usage requirement is matched for an itinerary sub-event included in the first itinerary event. For example, second resources matched for the itinerary sub-event 1 in Table 1 is an air ticket resource and a hotel resource, and a second resource matched for the itinerary sub-event 4 in Table 1 is a ticket resource. In this case, itinerary sub-events that have no matching are itinerary sub-events with missing resources in the first itinerary event, i.e., the itinerary sub-event 2 and the itinerary sub-event 3 shown in Table 1.

A “missing” resource herein may refer to a resource that can be used by the itinerary sub-event but cannot be provided by the resource provider, e.g., a Hong Kong Disneyland Park ticket or a Hong Kong Ocean Park ticket; or may be a static resource arranged in the itinerary. Content described in the former one is used as an example in the embodiments of the present disclosure.

It should be noted that “first” and “second” included in a “first resource” and a “second resource” described in the embodiments of the present disclosure have no special meaning, and merely represent different resources. The different resources described herein may be a same type of resources with attribute values of usage attributes of the resources being different, or may refer to different types of resources.

Third, the resource provider generates a resource search request according to the itinerary sub-event(s).

The resource search request is used to search for resources needed by the itinerary sub-event(s). The itinerary sub-event(s) herein can be understood as itinerary sub-event(s) with missing resources.

The content shown in Table 1 is used as an example. In the embodiments of the present disclosure, the resource provider generates a resource search request according to the itinerary sub-event 2 and the itinerary sub-event 3, i.e., requesting resources needed by the itinerary sub-event 2 and/or requesting resources needed by the itinerary sub-event 3.

It should be noted herein that whether hotel resources used in a trip change according to differences in itinerary sub-events, it is necessary to look at a distance between places of occurrences of different itinerary sub-events. If the distance is closer, the hotel resources used in this trip may be one or more. If more than one, these may be provided by one resource provider, or may be provided by multiple resource providers.

The resource provider may request hotel resource(s) when sending the resource search request to the resource sharing server, or may not request any hotel resource.

In the solutions described in the embodiments of the present disclosure, the missing resources in the itinerary sub-event 2 and the itinerary sub-event 3 are assumed to be not including a hotel resource. If the missing resources in the itinerary sub-event 2 and the itinerary sub-event 3 include hotel resources, this means that a hotel resource used by the itinerary sub-event 1 is different from those used by the itinerary sub-event 2 and the itinerary sub-event 3. In this case, the resource provider requests to obtain corresponding hotel resources when sending a resource acquisition request to the resource sharing server.

Finally, the resource provider sends the resource search request to the resource sharing server.

A second situation: A resource provider does not own resources used by an itinerary event.

In the second situation, the resource provider can only act as an originator of an itinerary event. For example, a travel agency determines a travel destination, a travel time, and a travel plan, and resources needed by an itinerary event require the resource provider to obtain from a resource sharing server. Specifically, using any of the above examples as an example, the resource provider is a travel agency. When the product information of “4-day Hong Kong travel” is published, Table 2 shows:

TABLE 2

| Itinerary event | Resources |
|---|---|
| Itinerary sub-event 1: From A to Hong | Null |
| Kong on 12.23 | |
| Itinerary sub-event 2: Travel in Hong | Null |
| Kong on 12.24 | |
| Itinerary sub-event 3: Travel in Hong | Null |
| Kong on 12.25 | |
| Itinerary sub-event 4: From Hong Kong to | Null |
| A on 12.26 | |

Then, in the second situation, the resource provider sends a resource acquisition request to the resource sharing server according to the itinerary event. The resource acquisition request is used for obtaining resources needed by the itinerary event, i.e., obtaining resources needed by the itinerary sub-event 1, resources needed by the itinerary sub-event 2, resources needed by the itinerary sub-event 3, and resources needed by the itinerary sub-event 4.

It should be noted that the resource provider described in the embodiments of the present disclosure may be a resource provider that provides air ticket resources, or may be a resource provider that provides hotel resources (including, but not limited to, accommodation resources), or may also be a resource provider that provides resources for places of attraction, which is not specifically limited herein. In the embodiments of the present disclosure, a resource party providing an itinerary event is taken as an example. Here, the resource party providing the itinerary event may be a travel agency. When providing the itinerary event, the travel agency may obtain resources needed by various itinerary sub-events included in the itinerary event through a number of methods. A first method is to obtain resources according to the solutions described in the embodiments of the present disclosure, and obtain resources provided by other resource providers through an Internet platform. A second method is to obtain resources through offline negotiation. A third method is a combination of the first two methods.

In the first method, it can be understood that different resource providers establish cooperative relationships with an Internet service platform, so that each resource that is published in the Internet platform can be shared and used by different resource providers.

Operation 102: Receive response information sent by the resource sharing server.

The response information includes a first resource that is included in product information published by a second resource provider and that is needed by the at least one itinerary sub-event.

In the embodiments of the present disclosure, the resource sharing server first receives the resource search request sent by the first resource provider. The resource search request includes an itinerary event and at least one itinerary sub-event in the itinerary event.

Here, the itinerary event may only include itinerary sub-event(s) with missing resources as described in the first situation at operation 101 of the embodiments of the present disclosure, i.e., including only the itinerary sub-event 2 and/or the itinerary sub-event 3. Alternatively, the itinerary event may include all itinerary sub-events as described in the second situation at operation 101 of the embodiments of the present disclosure. No specific limitations are imposed herein.

The resource sharing server searches for at least one resource that is needed by the resource search request from a shared resource library. The shared resource library includes a plurality of resources that provided by different resource providers and are demarcated according to usage attributes of the resources.

Here, the resource sharing server may receive a plurality of pieces of product information published by a plurality of different resource providers. Resources included in these pieces of product information may be shared by a plurality of different pieces of product information. As such, after receiving the plurality of pieces of product information published by different resource providers, the resource sharing server stores the resources included in the product information in a shared resource library, so that suitable resources can be provided to a resource provider when a search request sent by the resource provider is received.

A resource found by the resource sharing server for the itinerary sub-event 2 is assumed to be a Disneyland Park ticket resource; a resource found for the itinerary sub-event 3 is assumed to be an Ocean Park ticket resource.

Finally, the resource sharing server sends response information including the at least one resource that is found to the first resource provider.

Operation 103: Determine a correspondence relationship between the first resource and an itinerary sub-event that requires the first resource.

In the embodiments of the present disclosure, when a first resource (i.e., the Disneyland Park ticket resource and/or the Ocean Park ticket resource found at operation 102) is received, a correspondence relationship between the first resource and an itinerary sub-event that requires the first resource is determined.

Specifically, if the received first resource includes a Disneyland Park ticket resource and/or an Ocean Park ticket resource, then a correspondence relationship of the Disneyland Park ticket resource and/or the Ocean Park ticket resource with the itinerary sub-event 2 can be determined, or a correspondence relationship of the Disneyland Park ticket resource and/or the Ocean Park ticket resources with the itinerary sub-event 3 can be determined.

In another embodiment of the present disclosure, when receiving the response information sent by the resource sharing server, the method further includes:

selecting a third resource that satisfies a requirement of the itinerary sub-event from the received first resource when receiving the first resource, the third resource being used in synchronization in a second itinerary event.

Specifically, in practical applications, when the number of first resources found by the resource sharing server is relatively large, the first resource provider may perform filtering on the first resources that are found to obtain a third resource need by an itinerary sub-event with missing resources. At this time, a correspondence relationship between the itinerary sub-event and the third resource can be established.

In another embodiment of the present disclosure, the method further includes:

determining a second resource that is used by the first itinerary event and possessed by the first resource provider; and

combining the first resource/the third resource with the second resource to obtain a resource set corresponding to the first itinerary event.

For example, second resources (i.e., air ticket resources and hotel resources) that are used by the first itinerary event and have been possessed are determined. Furthermore, as previously assumed, a hotel resource in the itinerary sub-event 1 can be shared in the itinerary sub-event 2 and the itinerary sub-event 3. As such, a resource set corresponding to the first itinerary event is obtained through combination, i.e., a correspondence relationship between each itinerary sub-event and resource(s) needed thereby, as shown in Table 3:

TABLE 3

| Itinerary event | Resources |
|---|---|
| Itinerary sub-event 1: From A to Hong | Air ticket resource and hotel |
| Kong on 12.23 | resource |
| Itinerary sub-event 2: Travel in Hong | Disneyland Park ticket resource |
| Kong on 12.24 | and hotel resource |
| Itinerary sub-event 3: Travel in Hong | Ocean Park ticket resource and |
| Kong on 12.25 | hotel resource |
| Itinerary sub-event 4: From Hong Kong | Air ticket resource |
| to A on 12.26 | |

It should be noted that the first resource obtained at operation 102 also needs to include hotel resources if the hotel resource in the itinerary sub-event 1 is not shared in the itinerary sub-event 2 and the itinerary sub-event 3. The hotel resources here may be different from the hotel resource included in the itinerary sub-event 1. A resource set corresponding to the first itinerary event can be obtained through combination, as shown in Table 4:

TABLE 4

| Itinerary event | Resources |
|---|---|
| Itinerary sub-event 1: From A to Hong | Air ticket resource and |
| Kong on 12.23 | hotel resource 1 |
| Itinerary sub-event 2: Travel in Hong | Disneyland Park ticket |
| Kong on 12.24 | resource and hotel resource 2 |
| Itinerary sub-event 3: Travel in Hong | Ocean Park ticket resource |
| Kong on 12.25 | and hotel resource 3 |
| Itinerary sub-event 4: From Hong | Air ticket resource |
| Kong to A on 12.26 | |

In another embodiment of the present disclosure, the resource sharing server may find a plurality of first resources for a same itinerary sub-event. As such, before obtaining the resource set corresponding to the first itinerary event, the method further includes:

selecting a third resource satisfying a requirement of the first itinerary event from the received first resources when receiving the first resources, the third resource being used in synchronization in a second itinerary event.

The example described above is still taken as an example. If the resource sharing server finds the number of resources for the itinerary sub-event 2 is greater than one, the resource provider may select one resource from the received resources as a resource for the itinerary sub-event 2 when receiving the response information sent by the resource sharing server. Display priority levels can be determined for the received resources. When the product information is published, a resource with the highest priority level can be selected as a preferred resource used by the itinerary sub-event 2, and other resources that match the itinerary sub-event 2 act as backup resources for the itinerary sub-event 2.

It should be noted that one or more corresponding resources of a same type for different itinerary sub-events may be available, thus facilitating and satisfying multiple selections of the user.

Operation 104: Publish product information including the correspondence relationship in the resource sharing server.

In the embodiments of the present disclosure, when resources for each itinerary sub-event in an itinerary event are determined, product information is generated, and the product information includes the itinerary event and a correspondence relationship between each itinerary sub-event included in the itinerary event and resource(s) need by the respective itinerary sub-event. The product information is published in a resource sharing server.

In this way, when a user obtains the product information, the user can quickly determine resources included in the product information to determine whether to be satisfied with a travel arrangement, thereby improving the user experience about a resource provider.

In another embodiment of the present disclosure, the method further includes:

establishing, according to resources used in the product information, a corresponding relationship between the product information and each of the resources.

In the embodiments of the present disclosure, since the same resource can be shared and used in different product information, an inventory of resources can be better managed. A correspondence relationship between product information and each of the resources can be established when the product information is generated, i.e., product information corresponding to each resource is recorded. As such, once a certain piece of product information is locked or purchased, an inventory quantity of an associated resource can be adjusted in time.

In another embodiment of the present disclosure, the method further includes:

receiving order information sent by the resource sharing server, the order information including the second resource; and

adjusting an inventory quantity of the second resource according to the order information.

An adjustment here can be understood as locking resources included in an order regarding whether a reduction is made when the order is generated, and further reducing an amount of the locked resources when payment information is received.

In another embodiment of the present disclosure, the method further includes:

sending a prompt message in response to detecting that the inventory quantity of the second resource is less than a defined threshold, the prompt message being used for reminding to replenish the second resource.

In the embodiments of the present disclosure, once an inventory quantity of a resource is found to be less than a defined threshold, this indicates that the resource cannot satisfy a requirement. A system may send a prompt message at that time. The prompt message is used for reminding a first resource provider to make supplement to the resource. A supplement herein may refer to adding types of resource or increasing an amount of resources, which is not specifically limited herein.

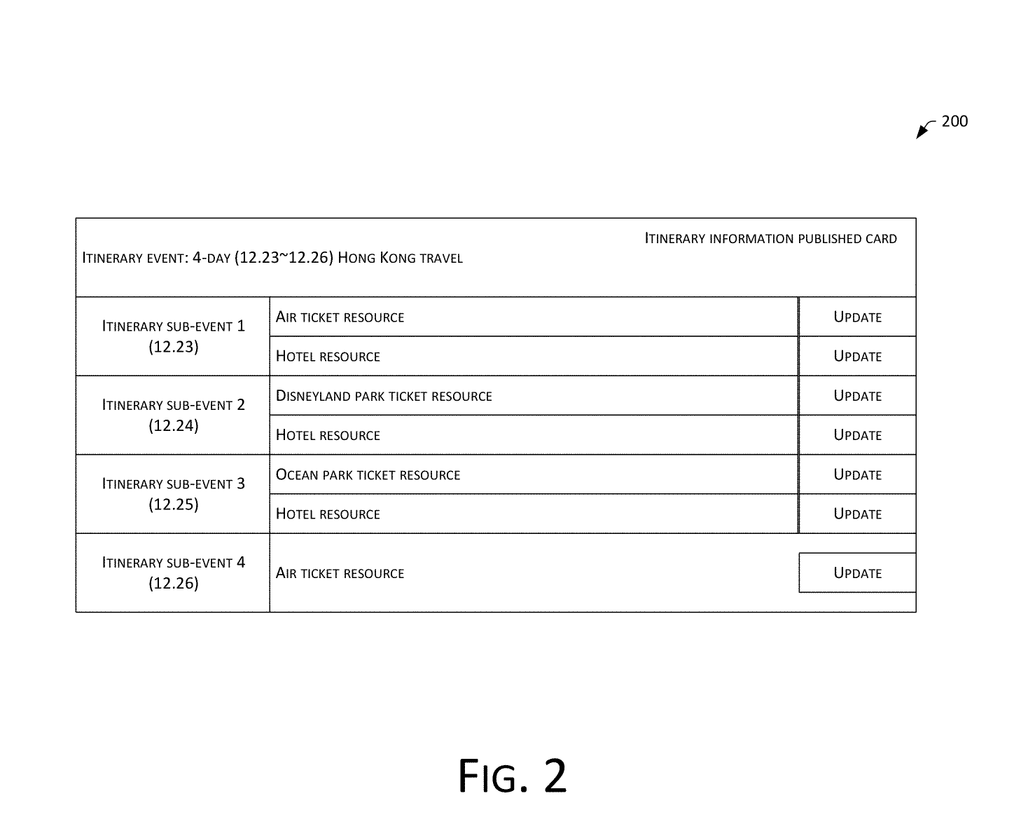

FIG. 2 is a schematic diagram of product information 200 published by a resource party according to the embodiments of the present disclosure.

As can be seen from FIG. 2, product information published by a resource provider includes not only an itinerary plan (i.e., an itinerary event), but also resources used by each itinerary sub-event in the itinerary event. As can be clearly seen from FIG. 2, different resources included in the product information published by the resource provider are independent of each other, which may come from a same resource provider, or may come from different resource providers. For each itinerary sub-event, corresponding resource(s) can be adjusted. Specifically, when a user does not like a resource provided by the resource provider, the resource included in the product information can be adjusted online to fulfill actual needs of the user.

It should be noted that, when product information is published as described in the embodiments of the present disclosure, a resource provider may separately publish product information including an individual itinerary sub-event in units of itinerary sub-events, and such product information includes the itinerary sub-event and resource(s) corresponding to the itinerary sub-event. Alternatively, the resource provider may publish product information including a plurality of itinerary sub-events, and these itinerary sub-events are successive or not successive. The embodiments of the present disclosure do not have any specific limitations thereon.

Through the technical solutions provided by the present disclosure, when publishing product information, a resource provider can dynamically obtain resource(s) matching an itinerary event included in the product information from a resource sharing server, so that the resources required for the entire itinerary event are relatively complete. This thus effectively improves the efficiency of obtaining the resources corresponding to the itinerary event from the resource sharing server by a user, and improves the user experience about network services provided by the resource sharing server. Furthermore, these resources may come from other resource providers, thus ensuring the efficiency of promoting resources provided by the resource providers in the resource sharing server, and thereby improving the turnover rate of the resources.

### Second Embodiment

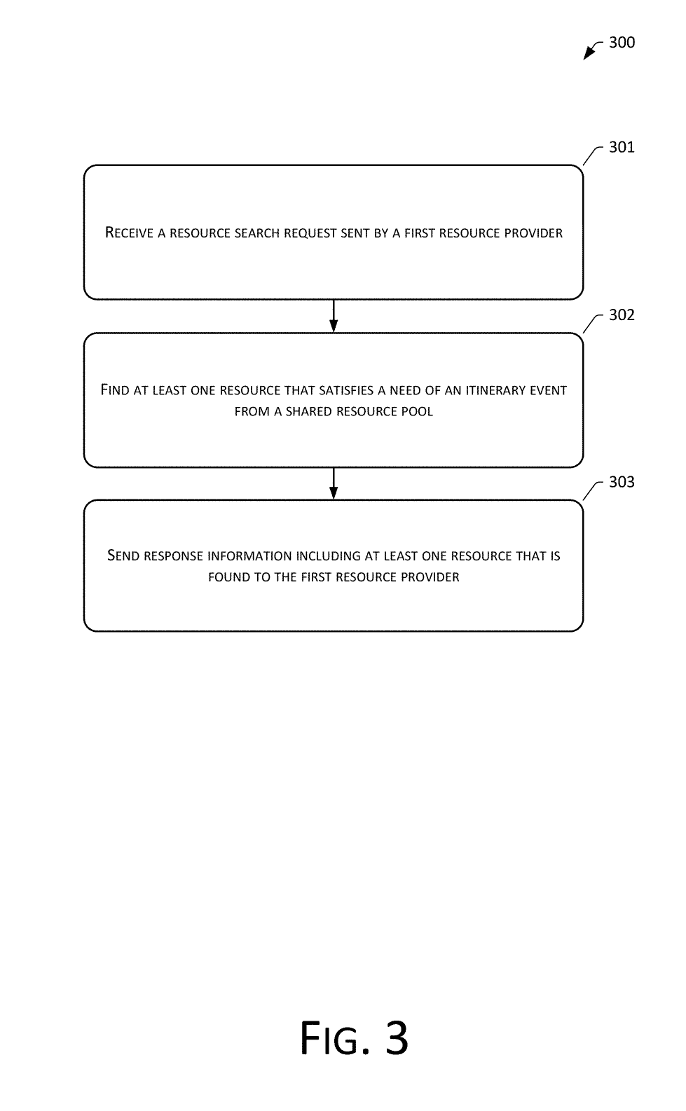

Based on the same inventive concept, FIG. 3 is a schematic flowchart of a resource processing method 300 according to an embodiment of the present disclosure. The method may be the one shown below. An execution entity of the embodiment of the present disclosure is a resource sharing server.

Operation: 301: Receive a resource search request sent by a first resource provider.

The resource search request includes an itinerary event.

In the embodiments of the present disclosure, the first resource provider may obtain required resources from the resource sharing server to form product information to be published based on the obtained resources. The product information described in the embodiments of the present disclosure may be regarded as a type of product. This type of product includes resources provided by different resource providers, which are combined in a loosely coupled manner, and the resources in the product can be shared with resources contained in other products.

Operation 302: Find at least one resource that satisfies a need of an itinerary event from a shared resource pool.

The shared resource library includes a plurality of resources that are provided by different resource providers and demarcated according to usage attributes of the resources. The usage attributes of the resources are determined according to different itinerary sub-events included in the itinerary event.

In the embodiments of the present disclosure, the resource sharing server receives product information sent by a plurality of different resource providers, analyzes a plurality of resources included in the product information, determines usage attribute(s) of each resource, establishes a mapping relationship between an attribute value of a usage attribute and a resource identifier of a corresponding resource, and creates a shared resource library according to the mapping relationship. Specifically, the shared resource library includes multiple resources that are provided by different resource providers and demarcated according to usage attributes of the resources.

Specifically, when receiving the resource search request sent by the resource provider, the resource sharing server determines a time attribute of an itinerary sub-event included in the resource search request based on the itinerary sub-event. The itinerary sub-event is an itinerary sub-event with missing resource(s) in the itinerary event. Resource(s) having an attribute value corresponding to a usage attribute satisfying the time attribute is/are searched and found from the shared resource library, and is/are taken as resource(s) satisfying a need of the itinerary event.

It should be noted that, in the embodiments of the present disclosure, the itinerary event included in the resource search request may include all itinerary sub-events of the entire itinerary event, or may include itinerary sub-event(s) with missing resource(s) in the itinerary event. Methods of searching a shared resource pool for resources that are used in an itinerary sub-event are the same, and are not repeatedly described herein.

Operation 303: Send response information including at least one resource that is found to the first resource provider.

### Third Embodiment

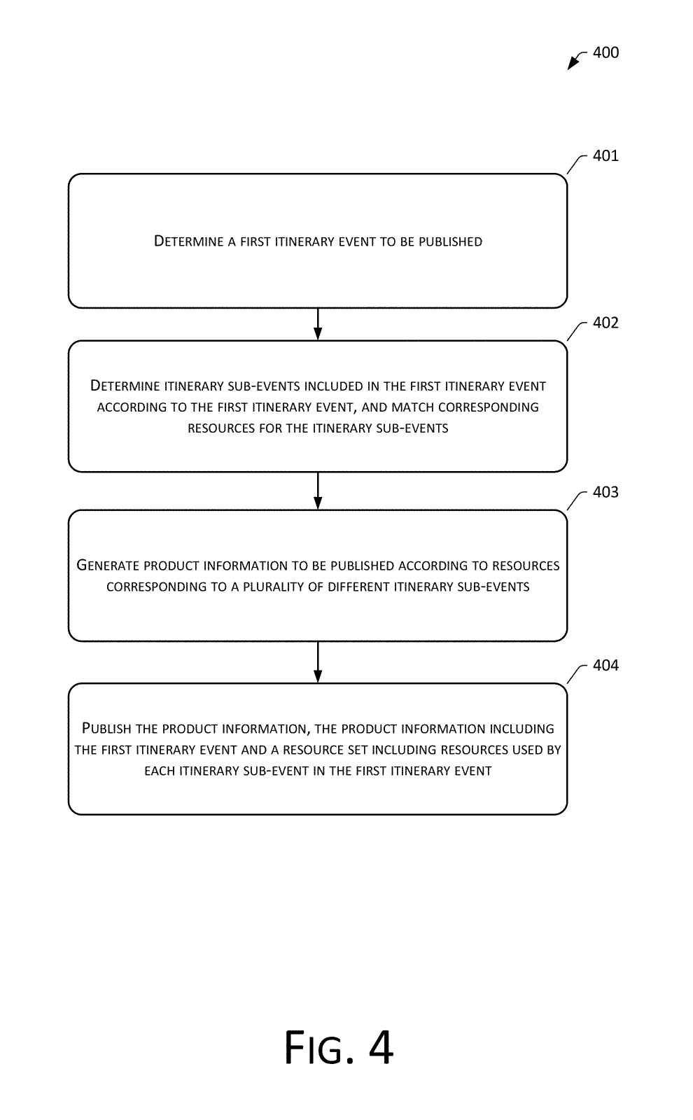

Based on the same inventive concept, FIG. 4 is a schematic flowchart of a resource processing method 400 according to an embodiment of the present disclosure. The method can be the one shown in the following. A difference between a solution provided by the present embodiment of the present disclosure is different from the solution provided in the first embodiment is that: a first resource provider described in the first embodiment needs to obtain all or part of resources from a resource sharing server when publishing product information, i.e., the first resource provider is able to provide a part of the resources of the product information; and a first resource provider described in the embodiment of the present disclosure is able to provide resources in product information, with a focus as manifesting a loosely coupling relationship between different resources included in product information published by a first resource provider, to help a resource sharing server to extract resources included in the product information when receiving the product information.

Operation 401: Determine a first itinerary event to be published.

In the embodiments of the present disclosure, a first resource provider determines an itinerary event, for example, “4-day (12.2312.26) Hong Kong travel.” This itinerary event can then be regarded as a first itinerary event.

Operation 402: Determine itinerary sub-events included in the first itinerary event according to the first itinerary event, and match corresponding resources for the itinerary sub-events.

In the embodiments of the present disclosure, based on a time attribute of an itinerary sub-event, a resource corresponding to an attribute value of a usage attribute satisfying the time attribute is matched to obtain resources corresponding to different itinerary sub-events.

Operation 403: Generate product information to be published according to resources corresponding to a plurality of different itinerary sub-events.

The resources included in the product information are shared with a second itinerary event published by a second resource provider in response to satisfying a need of the second itinerary event.

In the embodiments of the present disclosure, according to the resources corresponding to the plurality of different itinerary sub-events, product information to be published is obtained from combination in granularity of itinerary sub-events. The product information includes each itinerary event and resource(s) corresponding to the respective itinerary event, as shown in Table 5:

TABLE 5
4-day (12.23~12.26) Hong Kong travel-product information
Itinerary sub-event 1: 12.23 air ticket resource and hotel resource
Itinerary sub-event 2: 12.24 Disneyland Park ticket resource and hotel
resource
Itinerary sub-event 3: 12.25 Ocean Park ticket resource and hotel resource
Itinerary sub-event 4: 12.26 air ticket resource

In Table 5, each resource is independent of each other, and can be shared by other itinerary events.

It should be noted that, when the product information is published in the embodiment of the present disclosure, the product information including one itinerary sub-event may be separately published in units of the itinerary sub-event, and the merchandise information is included in the merchandise information. The ticket sub-event and the resource corresponding to the itinerary sub-event; the merchandise information including the plurality of itinerary sub-events may also be issued, and the itinerary sub-events are continuous or discontinuous, and are not specifically limited in the embodiment of the present disclosure.

For example: as shown in Table 6, product information to be published:

TABLE 6
4-day (12.23~12.26) Hong Kong travel-product information
Itinerary sub-event 1: 12.23 air ticket resource and hotel resource

As shown in Table 7, product information to be published:

TABLE 7
4-day (12.23~12.26) Hong Kong travel-product information
Itinerary sub-event 2: 12.24 Disneyland Park ticket resource and hotel
resource
Itinerary sub-event 3: 12.25 Ocean Park ticket resource and hotel resource

As shown in Table 8, product information to be published:

TABLE 8
4-day (12.23~12.26) HonG Kong travel-product information
Itinerary sub-event 4: 12.26 air ticket resource

Operation 404: Publish the product information, the product information including the first itinerary event and a resource set including resources used by each itinerary sub-event in the first itinerary event.

### Fourth Embodiment

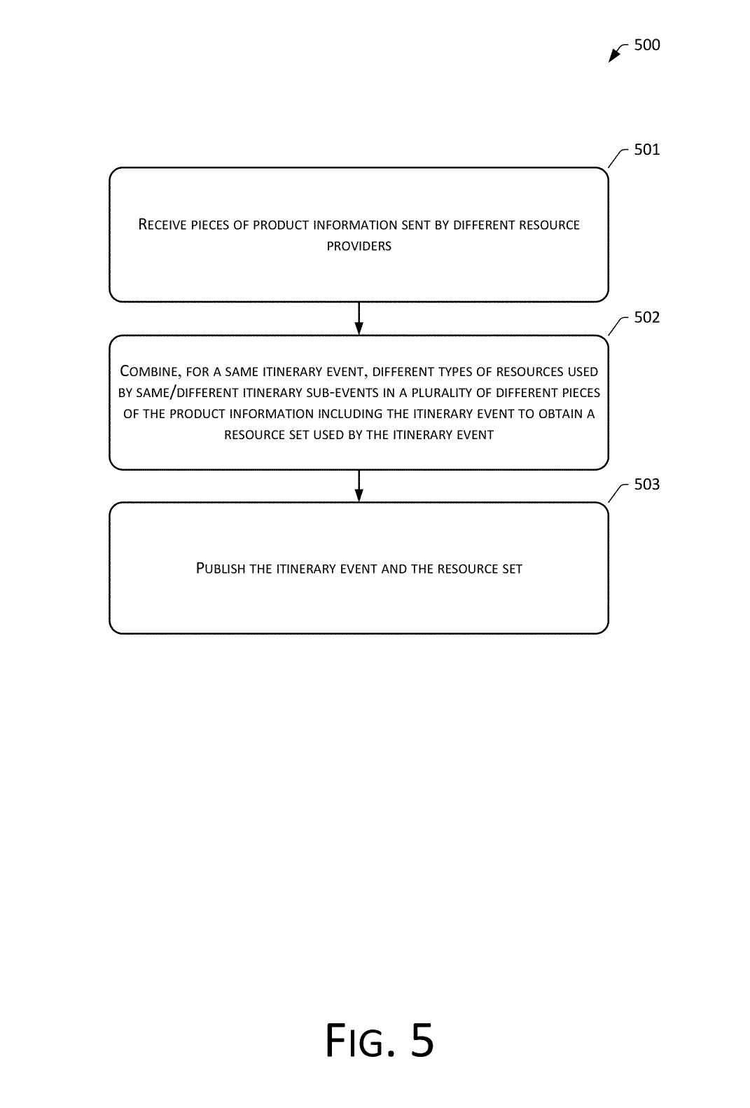

Based on the same inventive concept, FIG. 5 is a schematic flowchart of a resource processing method 500 according to an embodiment of the present disclosure. The method is described hereinafter. A solution described in the embodiment of the present disclosure may be applied in a resource sharing server, or may be applied in an Internet service platform, which is not specifically limited herein. The solution described in the embodiment of the present disclosure combines different types of resources by the resource sharing server in units of itinerary events. Being different from bundling methods in existing technologies, this type of combination mode adopts a manner of loose coupling, and is also able to be adjusted based on actual needs of a user to satisfy the needs of the user to the greatest extent.

Operation 501: Receive pieces of product information sent by different resource providers.

A piece of the product information includes an itinerary event and at least one resource used by an itinerary sub-event in the itinerary event.

In the embodiments of the present disclosure, an Internet service platform, which acts as an e-commerce platform, can publish resources provided by different resource providers in the Internet service platform, so as to provide services to users. In this way, the Internet service platform receives a resource publishing request sent by a resource provider, and obtains resource(s) to be published from the received resource publishing request.

These resources to be published may belong to a same type of resources or belong to different types of resources. In other words, a resource provider may request to publish same type of resource, or request to publish different types of resources. Different resource providers may provide a same type of resources, and alternatively provide different types of resources, which is not specifically limited herein.

It should be noted that a type described in the embodiments of the present disclosure may be determined according to a use of a resource, or may be determined according to other standards of the resource, which is not specifically limited herein.

When a plurality of different pieces of product information are received, itinerary events included in the plurality of different pieces of product information and different resources used by each itinerary sub-event in the itinerary events are analyzed.

Operation 502: Combine, for a same itinerary event, different types of resources used by same/different itinerary sub-events in a plurality of different pieces of the product information including the itinerary event to obtain a resource set used by the itinerary event.

In the embodiments of the present disclosure, for a same itinerary event, a plurality of pieces of product information may be received, or resources provided by different resource providers may be received. As such, one approach may be to perform resource allocation for a certain piece of product information. Another approach is to combine resources used by different itinerary sub-events in different pieces of product information, so that a resource set used by the itinerary event can be obtained.

A first approach: Perform resource allocation for a certain piece of product information.

Specifically, by analyzing a plurality of different pieces of product information, itinerary events included in the plurality of different pieces of product information can be determined. In this case, product information can be classified using itinerary events as a standard.

For example, product information of a same itinerary event is of a type. Here, the so-called same itinerary event may mean that travel destinations are the same. For example, all product information for traveling to Hong Kong is one type.

A type of product information is described in detail hereinafter.

First, for the itinerary event, product information including the itinerary event is determined.

Second, for a piece of the product information, the following operations are performed:

In the first operation, resource(s) missing from itinerary sub-event(s) in the itinerary event in the piece of product information is/are determined. Specifically,

determining itinerary sub-events included in the itinerary event based on the itinerary event;

respectively matching, for different itinerary sub-events, resources that are used for completing the itinerary sub-events according to resources included in the piece of product information;

determining, for an itinerary sub-event that has no matched resource, at least one type of resource used for completing the itinerary sub-event; and

using the at least one determined type of resource as a resource missing from the itinerary event in the piece of product information.

Specifically, when matching the resources that are used for completing the itinerary sub-events for different itinerary sub-events, time attributes of the itinerary sub-events may be determined for different itinerary sub-events;

Resources with attribute values corresponding to usage attributes satisfying the time attributes are used as the resources used for completing the itinerary sub-events.

In the second operation, the missing resource(s) is/are searched for from other pieces of the product information that are determined.

Specifically, time attribute(s) of the itinerary sub-event(s) corresponding to the missing resource(s) are determined.

Resource(s) with attribute value(s) corresponding to usage attribute(s) satisfying the time attribute(s) and being found from the other pieces of the product information that are determined is/are used as the missing resource(s)

In the third operation, the found missing resource(s) is/are combined with the resources already included in the product information to obtain a resource set used by the itinerary event.

A second approach: Combine resources used by different itinerary sub-events in different pieces of product information.

Specifically, a plurality of pieces of product information including a same itinerary event are determined for the itinerary event.

A time attribute of each itinerary sub-event included in each piece of the product information is determined.

According to the time attribute, different types of resources used by different itinerary sub-events in different pieces of the product information are combined to obtain a resource set used by the itinerary event.

For example, an itinerary event (4-day (12.2312.26) Hong Kong travel) is taken as an example. For this itinerary event, product information including the itinerary event is assumed to be composed of: product information 1 and product information 2. The itinerary event included in the product information 1 and resources used in each itinerary sub-event of the itinerary event are shown in Table 9:

TABLE 9
4-day (12.23~12.26) Hong Kong travel-product information 1
Itinerary sub-event 1: 12.23 air ticket resource 1 and hotel resource 1
Itinerary sub-event 2: 12.24 hotel resource 1
Itinerary sub-event 3: 12.25 hotel resource 1
Itinerary sub-event 4: 12.26 air ticket resource 2

The itinerary event included in the product information 2 and resources used in each itinerary sub-event in the itinerary event are shown in Table 10:

TABLE 10
4-day (12.23~12.26) Hong Kong travel-product information 2
Itinerary sub-event 1: 12.23 air ticket resource 3 and hotel resource 2
Itinerary sub-event 2: 12.24 Disneyland Park ticket resource
and hotel resource 2
Itinerary sub-event 3: 12.25 Ocean Park ticket resource and
hotel resource 2
Itinerary sub-event 4: 12.26 air ticket resource 4

After receiving these two pieces of product information, different types of resources used in different itinerary sub-events in different pieces of the product information may be combined according to the time attribute of each itinerary sub-event to obtain a resource set used by the itinerary event as shown in Table 11:

TABLE 11
4-day (12.23~12.26) Hong Kong travel-product information
Itinerary sub-event 1: 12.23 air ticket resource 1 and hotel resource 1
Itinerary sub-event 2: 12.24 Disneyland Park ticket resource
and hotel resource 2
Itinerary sub-event 3: 12.25 Ocean Park ticket resource and
hotel resource 2
Itinerary sub-event 4: 12.26 air ticket resource 2

As can be seen from Table 11, resources used for the itinerary sub-event 1 and the itinerary sub-event 4 are come from the product information 1, and resources used by the itinerary sub-event 2 and the itinerary sub-event 3 are come from the product information 2. In addition, other combination methods may exist. The combination method here includes a combination of different types of resources of a same itinerary sub-event, for example, resource corresponding to the itinerary sub-event 1 after combination is 12.23 ticket resource 1 and hotel resource 2, i.e., the ticket resource is come from the product information 1, and the hotel resource is from the product information 2, which is not exhaustively exemplified herein. It should be noted that this type of combination also needs to consider time attributes, and usage attributes of different resources need to satisfy a travel arrangement of the user.

Furthermore, in the embodiments of the present disclosure, resources included in the resource set corresponding to the same itinerary event are the same.

Alternatively, resources of a same type included in the resource set corresponding to different itinerary events are the same.

An itinerary event (4-day (12.2312.26) Hong Kong travel) is assumed to be corresponding to three pieces of product information: first product information 1 which includes 12.23 a ticket resource to Hong Kong and 12.26 a ticket resource from Hong Kong back to a place of departure; second product information 2 which includes a hotel resource for accommodation in Hong Kong and a ticket resource to and from Hong Kong; third product information 3 which includes a ticket resource to Hong Kong Disneyland Park and a ticket resource to Hong Kong Ocean Park.

For the product information 1, if it is Hong Kong free travel, a missing resource in the product information 1 is a hotel resource for users who like to go shopping in Hong Kong. In this case, the hotel resource can be found from the product information 2, so that the hotel resource in the product information 2 is shared with the product information 1, i.e., a resource set for combined product information 1 can be obtained as shown in Table 12:

TABLE 12
4-day (12.23~12.26) Hong Kong travel-product information 1
Itinerary sub-event 1: 12.23 air ticket resource and hotel resource
Itinerary sub-event 2: 12.24 hotel resource
Itinerary sub-event 3: 12.25 hotel resource
Itinerary sub-event 4: 12.26 air ticket resource

For the product information 2, or visitors to Hong Kong may want to go to Disneyland Park to a large extent. If a missing resource in the product information 2 is a ticket resource of Disneyland Park, such ticket resource can be found from the product information 3, so that the ticket resource of the product information 3 is shared with the product information 2, and a resource set of combined product information 2 can be obtained as shown in Table 13:

TABLE 13
4-day (12.23~12.26) Hong Kong travel-product information 2
Itinerary sub-event 1: 12.23 air ticket resource and hotel resource
Itinerary sub-event 2: 12.24 Disneyland Park ticket resource and hotel
resource
Itinerary sub-event 3: 12.25 Disneyland Park ticket resource and hotel
resource
Itinerary sub-event 4: 12.26 air ticket resource

For the product information 3, only tickets for Hong Kong tourism resources are included. As such, an air ticket resource to and from Hong Kong, and a hotel resource correspond to missing resources of the product information 3. The air ticket resource can be selected from the product information 1 or the product information 2, and the hotel resource can also be selected from the product information 2. Accordingly, a resource set of combined product information 3 can be obtained as shown in Table 14:

TABLE 14
4-day (12.23~12.26) Hong Kong travel-product information 3
Itinerary sub-event 1: 12.23 air ticket resource and hotel resource
Itinerary sub-event 2: 12.24 Disneyland Park ticket resource and hotel
resource
Itinerary sub-event 3: 12.25 Ocean Park ticket resource and hotel resource
Itinerary sub-event 4: 12.26 air ticket resource

Operation 503: Publish the itinerary event and the resource set.

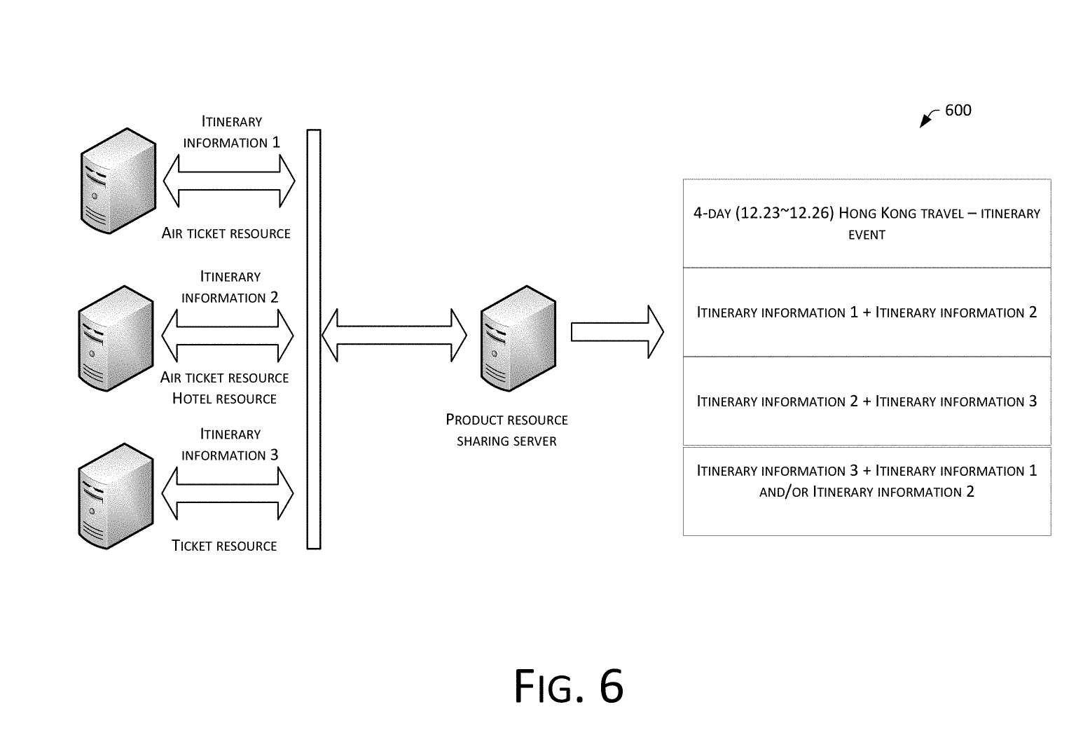

FIG. 6 is a schematic diagram of a resource set 600 provided by an embodiment of the present disclosure.

As can be seen from FIG. 6, after a resource sharing server obtains product information from different resource providers, resources included in the product information can be combined according to different pieces of product information to obtain complete resource sets of the product information, so that a user is enabled to determine a travel plan conveniently and quickly. At the same time, resources of these resource sets can be shared and used in multiple pieces of product information, thus ensuring the efficiency of promoting resources provided by a resource provider in the resource sharing server, and thereby improving the turnover rate of the resources.

In another embodiment provided by the present disclosure, the method further includes:

receiving a payment request sent by a user, the payment request including a resource set corresponding to an itinerary event determined by the user;

determining resource providers of resources included in the resource set; and

sending corresponding payment information to different resource providers according to payment information of the resources included in the resource set.

Specifically, for product information provided by the resource sharing server, once a user decides to purchase the product information, a payment request is sent to the resource sharing server. In the embodiments of the present disclosure, since resources included in a resource set corresponding to the product information may come from different resource providers, the resource sharing server needs to send respective pieces of payment information to providers corresponding to the resources according to the resources in the resource set when the resource sharing server receives the payment request from the user, thus simplifying a payment process for this type of combined resource set.

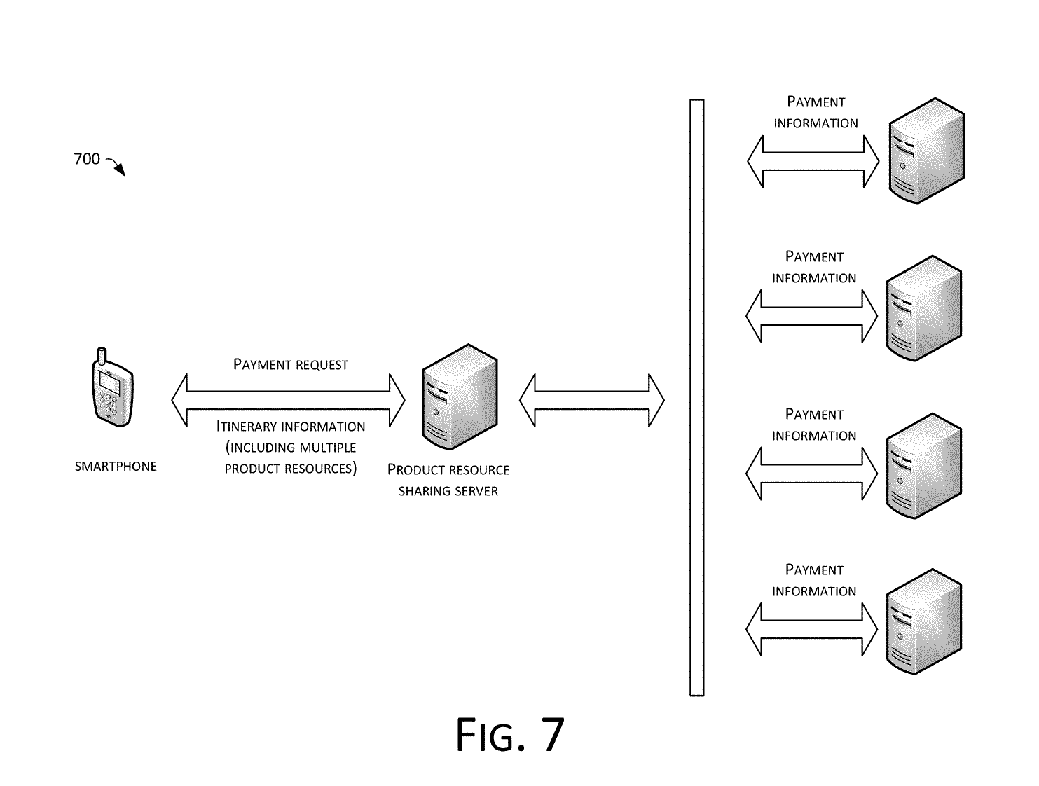

FIG. 7 is a schematic diagram of a resource payment scenario 700 provided by an embodiment of the present disclosure.

As can be seen from FIG. 7, only one payment is required for a user. For resource providers, a resource sharing server can send, according to resources in a resource set, respective pieces of payment information to providers corresponding to the resources, thus simplifying a payment process of this type of combined resource set and improving the efficiency of promoting this type of combined resource set.

In another embodiment provided by the present disclosure, the method further includes:

separately adjusting inventory quantities of different resources included in the resource set according to the resource set corresponding to the itinerary event determined by the user included in the payment request when receiving the payment request sent by the user.

In another embodiment provided by the present disclosure, separately adjusting the inventory quantities of the different resources included in the resource set includes:

determining resource providers of the different resources included in the resource set; and

sending respective inventory adjustment information to the resource providers of the different resources, to cause the resource provider to adjust the inventory quantities of the resources included in the respective inventory adjustment information when receiving the respective inventory adjustment information.

In another embodiment provided by the present disclosure, the method further includes:

sending a prompt message in response to detecting that an inventory quantity of a resource is less than a defined threshold, the prompt message being used for reminding a supplement of the resource.

In another embodiment of the present disclosure, since a resource may not only be published in an Internet service platform, but may also be published in multiple Internet service platforms, or shared in multiple itinerary events, once an itinerary event generates order information, this means that the resource is sold. Therefore, in order to avoid a situation of “oversold: the method further includes:

monitoring an inventory status of each resource included in the resource set; and

adjusting a resource included in the resource set when an inventory status of the resource included in the resource set is changed to empty.

In the embodiments of the present disclosure, multiple resource sets may be determined and obtained for an itinerary event, i.e., multiple resource sets may exist for the itinerary event. When recommending product information to a user, an Internet service platform may recommend a resource set, or may recommend multiple resource sets, and provide an update control for each resource in each resource set. Specifically, the user can be provided with other resources of a type that is the same as that of a resource when an associated update control is triggered, so that the user can flexibly select resources that are needed to meet the needs of the user.

It should be noted that a plurality of resource sets corresponding to an itinerary event may be displayed in a form of a list, a set, or a flat layout, which is not specifically limited herein.

In the technical solutions provided by the embodiments of the present disclosure, a resource provider performs a refinement on resources according to a degree of granularity of itinerary sub-events, so that a resource sharing server can combine resources included in product information when receiving the product information published by different resource providers. This ensures that a user can clearly understand various types of resources included in a resource set when obtaining the resource set. As such, personalization and refinement of network services provided by the resource sharing server are improved, and the user experience about the network services is improved, effectively changing the turnover efficiency of resources provided by the resource sharing server.

### Fifth Embodiment

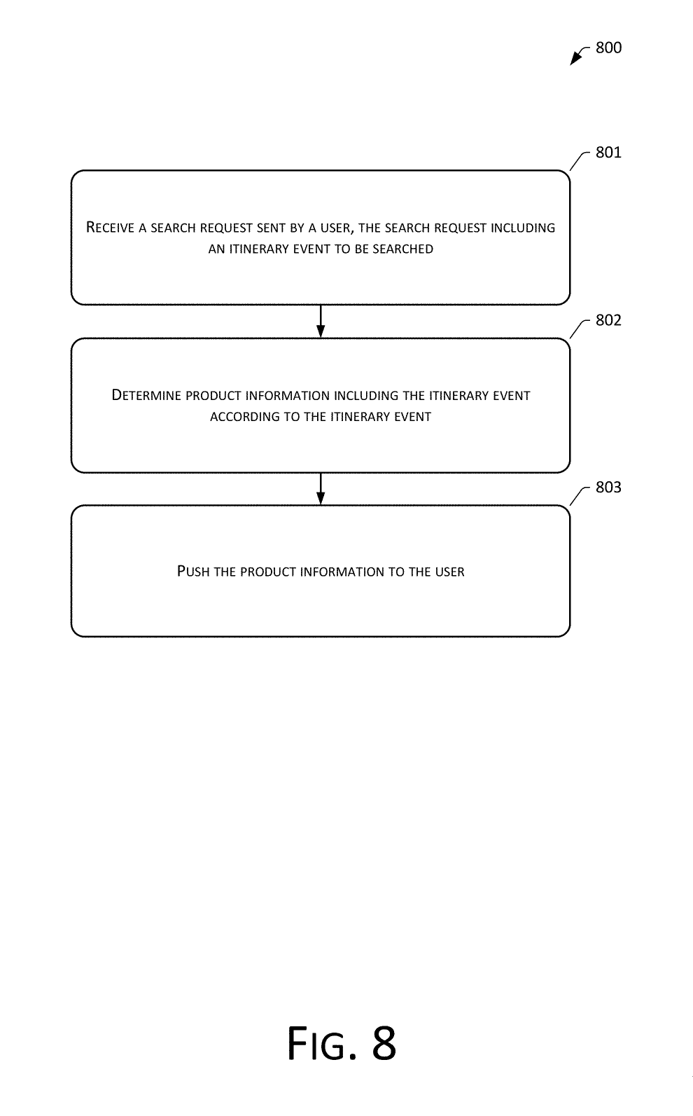

Based on the same inventive concept, FIG. 8 is a schematic flowchart of a resource processing method 800 according to an embodiment of the present disclosure. The method can be the one shown as follows.

Operation 801: Receive a search request sent by a user, the search request including an itinerary event to be searched.

Operation 802: Determine product information including the itinerary event according to the itinerary event.

The product information includes a correspondence relationship between resources used by itinerary sub-events in the itinerary event and the itinerary sub-events.

A method of generating product information can be determined by the methods described in the above embodiments, and is not repeatedly described herein.

Operation 803: Push the product information to the user.

In another embodiment provided by the present disclosure, the method further includes:

receiving a resource changing request sent by the user, the resource changing request including a resource identifier;

determining a type of a resource corresponding to the resource identifier and an attribute value of a usage attribute;

searching a shared resource library for resource(s) of the same type and having a different attribute value of the usage attribute, and pushing a resource that is found to the user, where the shared resource library includes a plurality of resources that are provided by different resource providers and demarcated according to usage attributes of the resources.

Alternatively, the method further includes:

receiving a resource changing request sent by the user, the resource changing request including an itinerary sub-event;

calculating a time interval for completing the itinerary sub-event according to a time attribute of the itinerary sub-event;

finding other resource(s) satisfying the time interval and being different from resource(s) that have been pushed from a shared resource library, and pushing the other resource(s) that is/are found to the user.

It should be noted that, in the embodiments of the present disclosure, an itinerary sub-event may correspond to one resource, or may correspond to a plurality of resources. When performing a push to a user, the resource sharing server selects a resource to be pushed to the user for each itinerary sub-event according to display priority levels of different resources. In this way, when receiving resource changing request sent by the user, other resources may be pushed to the user in an order according to the display priority levels.

In another embodiment provided by the present disclosure, the method further includes:

receiving order information sent by the user, the order information including product information selected by the user, and the product information including a correspondence relationship between at least one itinerary sub-event in the itinerary event selected by the user and resource(s) needed by the itinerary sub-event; and

locking the resource(s) included in the product information according to the product information.

In another embodiment provided by the present disclosure, the method further includes:

receiving first payment information sent by the user, the first payment information being used for paying product information selected by the user;

determining a respective resource provider that provides each resource in the product information and respective second payment information of each resource in the product information based on the product information, a sum of the respective second payment information of each resource being equal to the first payment information; and

separately sending payment data to the respective resource provider corresponding to each resource according to the respective second payment information of each resource.

In another embodiment provided by the present disclosure, the method further includes:

separately adjusting a respective inventory quantity of each resource included in the product information according to the product information included in payment information in response to receiving the payment information transmitted by the user.

In another embodiment provided by the present disclosure, separately adjusting a respective inventory quantity of each resource included in the product information includes:

determining a respective resource provider of each resource included in the product information; and

separately sending respective inventory adjustment information to the respective resource provider of each resource, to cause the respective resource provider to adjust an inventory quantity of the respective resource included in the respective inventory adjustment information when receiving the respective inventory adjustment information.

If a user A enters an itinerary event in a search box, a product resource sharing server (or an Internet service platform) searches for product information including the itinerary event according to the itinerary event, and pushes product information that is found to the user A. The product information that is pushed to the user A is not only able to allow the user to view resource(s) corresponding to each itinerary sub-event of the itinerary event, but also able to provide alternative resource(s) for each itinerary sub-event, so that the user can obtain the itinerary event in a more flexible manner.

Furthermore, once the product resource sharing server (or the Internet service platform) determines that the user selects certain product information, the user may send a payment request to the product resource sharing server (or the Internet service platform). The payment request is used for making a payment for the product information. Specifically, the user only needs to make a single payment for the product information composed of different resources. When receiving the payment request, the product resource sharing server (or the Internet service platform) determines a respective resource provider of each resource included in the product information, and separately sends corresponding payment information to each resource provider, where the payment information is payment information used for making respective payments for resources provided by resource providers.

### Sixth Embodiment

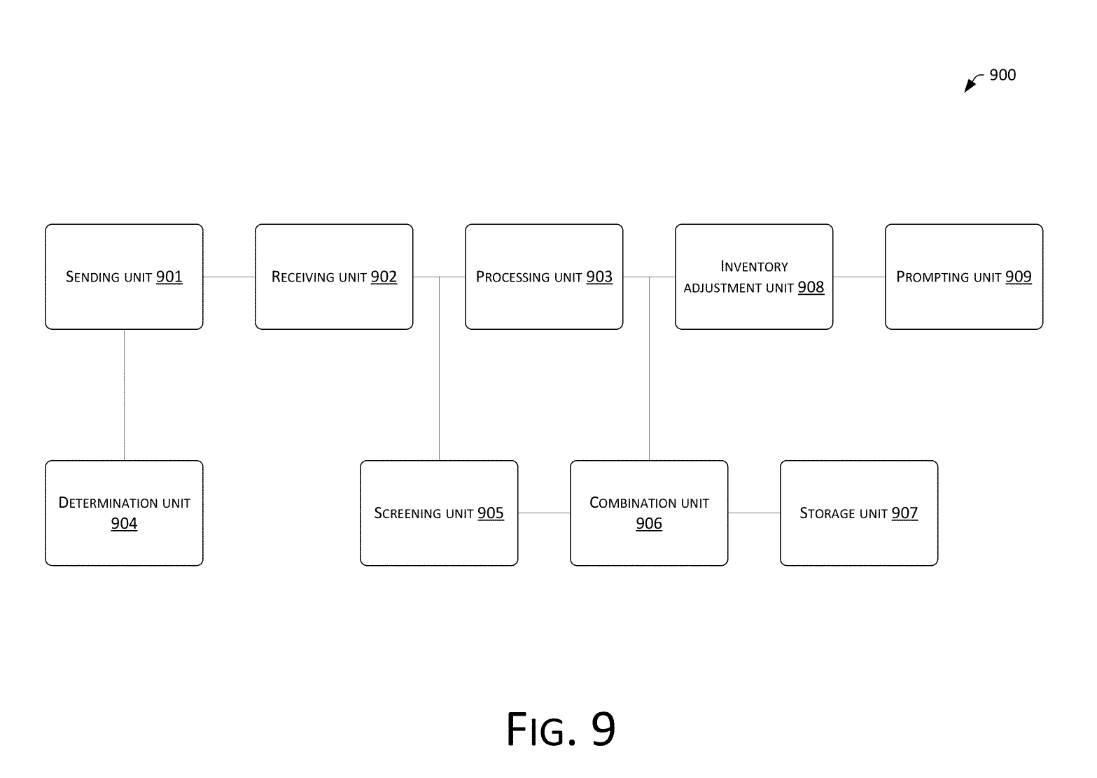

Based on the same inventive concept, FIG. 9 is a schematic structural diagram of a resource processing device 900 according to an embodiment of the present disclosure. The resource processing device provided by the embodiment of the present disclosure is applied in a server corresponding to a first resource provider. The resource processing device includes a sending unit 901, a receiving unit 902, and a processing unit 903.

The sending unit 901 sends a resource search request to a resource sharing server, the resource search request including at least one itinerary sub-event in a first itinerary event.

The receiving unit 902 receives response information sent by the resource sharing server, the response information including at least one first resource included in product information that is published by a second resource provider and needed by the itinerary sub-event.

The processing unit 903 determines a correspondence relationship between the first resource and the itinerary sub-event that needs the first resource, and publishes product information including the correspondence relationship in the resource sharing server.

In another embodiment of the present disclosure, the resource processing device further includes a determination unit 904, wherein:

the determination unit 904 determines the first itinerary event to be published and second resource(s) used by the at least one itinerary sub-event in the first itinerary event before sending the resource search request to the resource sharing server, and determines itinerary sub-event(s) with missing resource(s) in the first itinerary event based on the second resource(s).

In another embodiment of the present disclosure, the sending unit 901 sending the resource search request to the resource sharing server includes:

generating the resource search request according to the itinerary sub-event, the resource search request being used for searching for resources needed by the itinerary sub-event; and

sending the resource search request to the resource sharing server.

In another embodiment provided by the present disclosure, the resource processing device 900 further includes a screening unit 905, wherein:

the screening unit 905, before receiving the resource set corresponding to the first itinerary event, selecting third resource(s) satisfying the first itinerary event from the first resource that is received when receiving the first resource, the third resource(s) being used in synchronization with a second itinerary event.

In another embodiment provided by the present disclosure, the resource processing device 900 further includes: a combination unit 906, wherein:

the combination unit 906 determines second resource(s) used by the first itinerary event and owned by the first resource provider, and combines the first resource/the third resource(s) with the second resource(s) to obtain the resource set corresponding to the first itinerary event.

In another embodiment provided by the present disclosure, the resource processing device 900 further includes a storage unit 907, wherein:

the storage unit 907 establishes a correspondence relationship between the product information and each resource according to resources used in the product information.

In another embodiment provided by the present disclosure, the resource processing device 900 further includes an inventory adjustment unit 908, wherein:

the inventory adjustment unit 908 receives order information sent by the resource sharing server, the order information including the second resource, and adjusts an inventory quantity of the second resource according to the order information.

In another embodiment provided by the present disclosure, the resource processing device 900 further includes a prompting unit 909, wherein:

the prompting unit 909 sends a prompt message in response to detecting that an inventory quantity of the second resource is less than a defined threshold, the prompt message being used to remind a supplement of the second resource.

It should be noted that the resource processing device provided by the embodiments of the present disclosure may be implemented using a software, or hardware, which is not specifically limited herein. When publishing product information, the product processing device can dynamically obtain the resources matching the itinerary event included in the product information from the resource sharing server, so that the resources needed by the entire itinerary event are relatively complete. This effectively improves the efficiency of obtaining the resources corresponding to the itinerary event from the resource sharing server by the user, and improves the user experience about network services provided by the resource sharing server. Furthermore, these resources may come from other resource providers, ensuring the promotion efficiency of the resources provided by resource providers in the resource sharing server, and thereby improving the turnover rate of resources.

### Seventh Embodiment

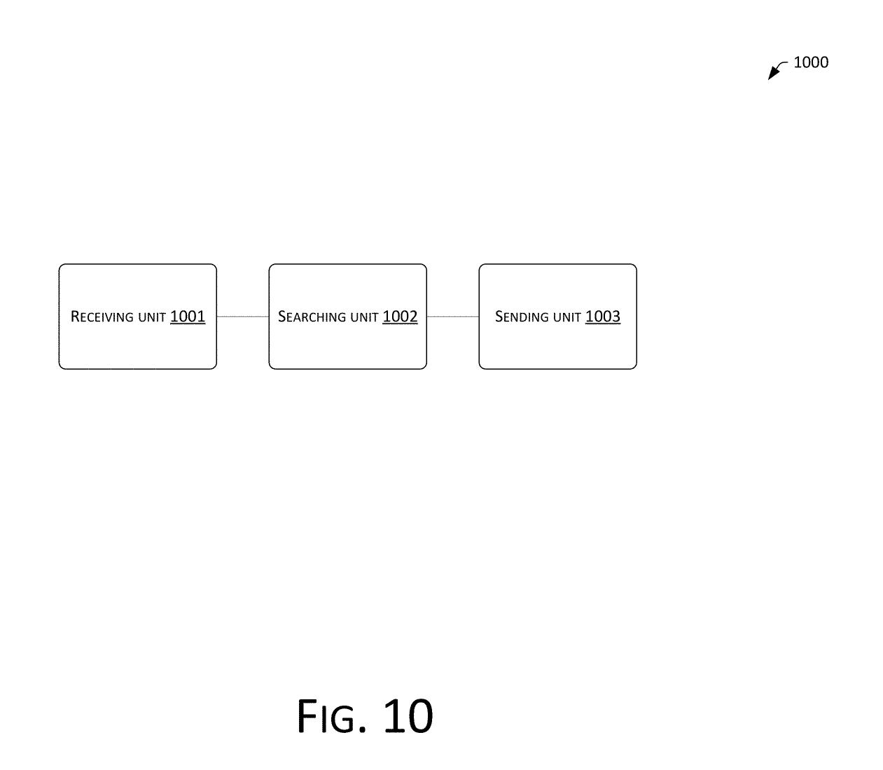

Based on the same inventive concept, FIG. 10 is a schematic structural diagram of a resource processing device 1000 according to an embodiment of the present disclosure. The resource processing device includes a receiving unit 1001, a searching unit 1002, and a sending unit 1003.

The receiving unit 1001 receives a resource search request sent by a first resource provider, the resource search request including an itinerary event.

The searching unit 1002 searches a shared resource library for at least one resource that satisfies requirements of the itinerary event, the shared resource library including multiple resources that are provided by different resource providers and are demarcated according to usage attributes of the resources, wherein the usage attributes of the resources are determined according to itinerary sub-events included in different itinerary events.

The sending unit 1003 sends response information including the at least one resource that is found to the first resource provider.

In another embodiment provided by the present disclosure, the searching unit 1002 searching the shared resource library for the at least one resource that satisfies the requirements of the itinerary event includes:

determining a time attribute of the itinerary sub-event based on the itinerary sub-event included in the resource search request, the itinerary sub-event being an itinerary sub-event with a missing resource in the itinerary event; and

taking a resource having an attribute value corresponding to a usage attribute satisfying the time attribute as a resource that satisfies the requirements of the itinerary event.

It should be noted that the resource processing device provided by the embodiments of the present disclosure may be implemented in a form of hardware, or may be implemented in a form of software, which is not limited herein.

### Eighth Embodiment

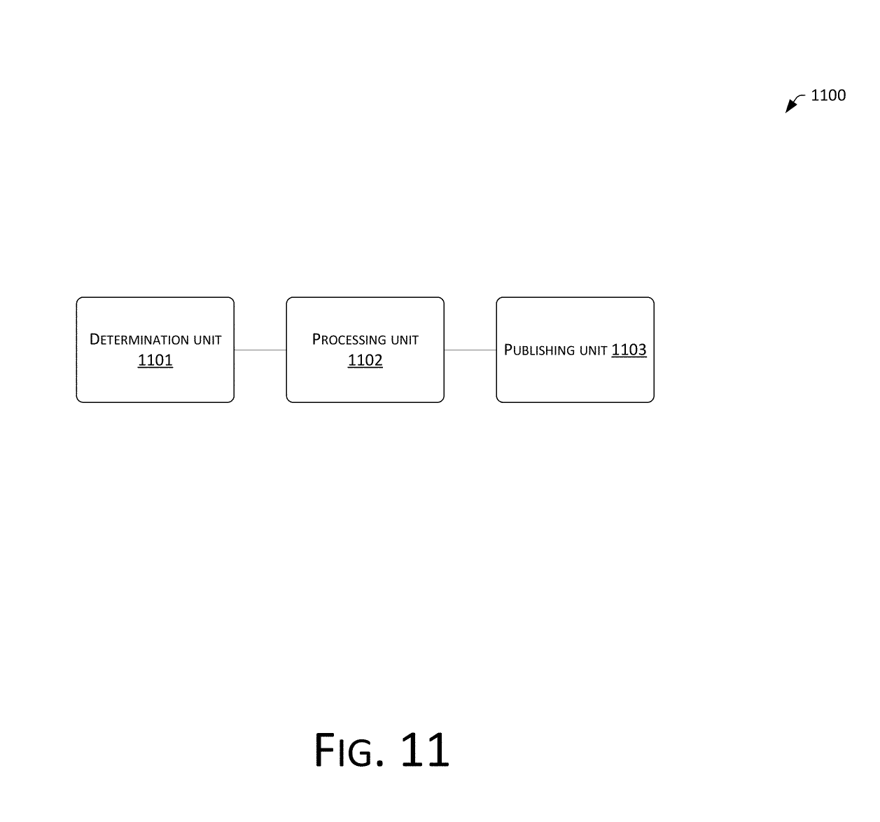

Based on the same inventive concept, FIG. 11 is a schematic structural diagram of a resource processing device 1100 according to an embodiment of the present disclosure. The resource processing device includes a determination unit 1101, a processing unit 1102, and a publishing unit 1103.

The determination unit 1101 determines a first itinerary event to be published, determines an itinerary sub-event included in the first itinerary event based on the first itinerary event, and matches a corresponding resource for the itinerary sub-event.

The processing unit 1102 generates product information to be published according to resources corresponding to different itinerary sub-events, resources included in the product information being shared with a second itinerary event in response to satisfying a need of the second itinerary event published by a second resource provider.

The publishing unit 1103 publishes the product information, the product information including the first itinerary event and a product resource set including product resources used by the first itinerary event.

It should be noted that the resource processing device provided by the embodiments of the present disclosure may be applied to a server corresponding to a first resource provider, or may be applied to a server corresponding to another resource provider. The resource processing device may be implemented in a form of software, or may be implemented in a form of hardware, which is not specifically limited herein.

### Ninth Embodiment

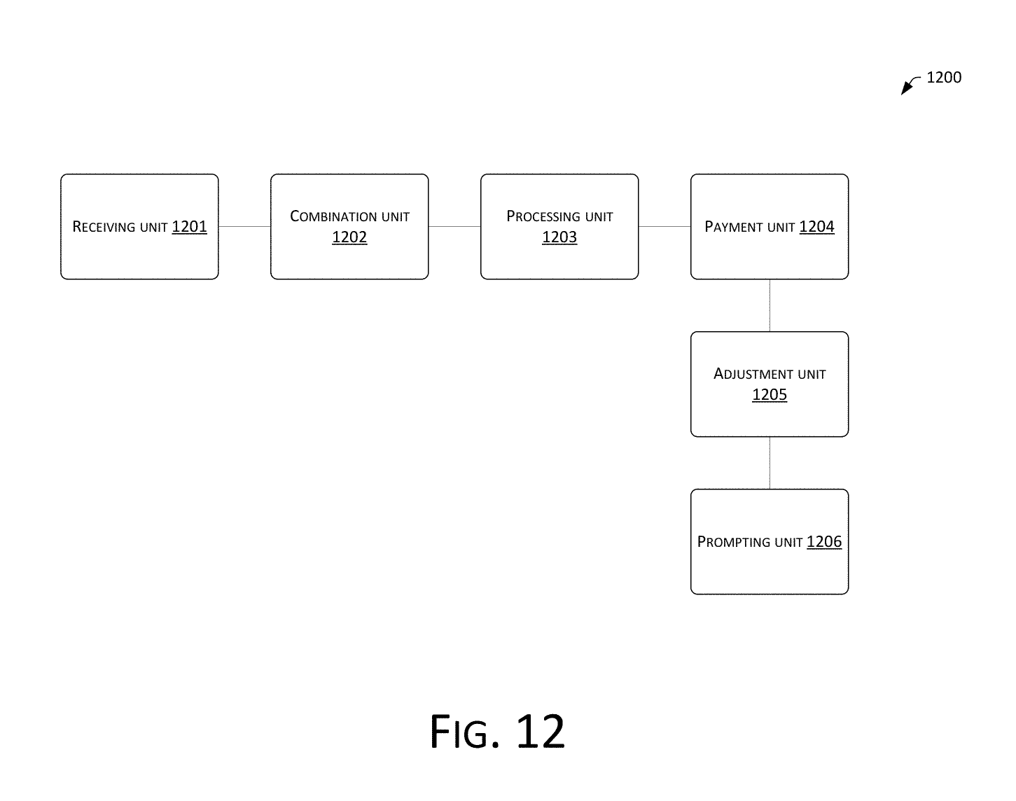

Based on the same inventive concept, FIG. 12 is a schematic structural diagram of a resource processing device 1200 according to an embodiment of the present disclosure. The resource processing device includes a receiving unit 1201, a combination unit 1202, and a processing unit 1203.

The receiving unit 1201 receives a plurality of pieces of product information sent by different resource providers, the plurality of pieces of product information including an itinerary event and at least one resource used by an itinerary sub-event in the itinerary event.

The combination unit 1202 combines different types of resources used by same/different itinerary sub-events in different pieces of product information that include the itinerary event to obtain a resource set used by the itinerary event for the same itinerary event.

The processing unit 1203 publishes the itinerary event and the resource set.

In another embodiment provided by the present disclosure, the combination unit 1202 combining the different types of resources used by the same/different itinerary sub-events in the different pieces of product information that include the itinerary event to obtain the resource set used by the itinerary event for the same itinerary event includes:

determining pieces of product information including the itinerary event based on the same itinerary event; and

for a piece of the product information, performing the following:

determining a resource that is missing from the itinerary sub-event in the itinerary event in the piece of the product information;

finding the missing resource from other pieces of the product information that are determined; and

combining the missing resource that is found with resources that are already included in the product information to obtain the resource set used by the itinerary event.

In another embodiment provided by the present disclosure, the combination unit 1202 determining the resource that is missing from the itinerary event in the piece of the product information includes:

determining itinerary sub-events included in the itinerary event based on the itinerary event;

matching resources used for completing the itinerary sub-events for different itinerary sub-events based on resources included in the piece of the product information;

determining, for an itinerary sub-event having no matched resource, at least one type of resource used for completing the itinerary sub-event; and

taking the at least one determined type of resource as the resource missing from the itinerary event in the piece of the product information.

In another embodiment provided by the present disclosure, the combination unit 1202 matching the resources used for completing the itinerary sub-events for the different itinerary sub-events includes:

determining respective time attributes of the itinerary sub-events for the different itinerary sub-events; and

using resources having respective attribute values corresponding to usage attributes satisfying the respective time attributes as the resources used for completing the itinerary sub-events.

In another embodiment provided by the present disclosure, the combination unit 1202 finding the missing resource from other pieces of the product information that are determined includes:

determining a time attribute of an itinerary sub-event corresponding to the missing resource; and

searching the other pieces of the product information that are determined for a resource having an attribute value corresponding to a usage attribute that satisfies the time attribute as the missing resource.

In another embodiment provided by the present disclosure, the combination unit 1202 combining the different types of resources used by the same/different itinerary sub-events in the different pieces of the product information that include the itinerary event to obtain the resource set used by the itinerary event for the same itinerary event, includes:

determining a plurality of pieces of product information including the itinerary event based on the same itinerary event;

determining a respective time attribute of each itinerary sub-event included in each piece of the product information; and

combining different types of resources used by the different itinerary sub-events in the different pieces of the product information to obtain the resource set used by the itinerary event according to the respective time attribute.

In another embodiment provided by the present disclosure, portions that correspond to resources in resource sets corresponding to the same itinerary event are the same; or portions that correspond to resources of a same type included in resource sets corresponding to different itinerary events are the same.

In another embodiment provided by the present disclosure, the resource processing device 1200 further includes a payment unit 1204.

The payment unit 1204 receives a payment request sent by a user, the payment request including a resource set corresponding to an itinerary event determined by the user, determines respective resource providers of resources included in the resource set, and sends corresponding payment information to different resource providers according to respective payment information of the resources included in the resource set.

In another embodiment provided by the present disclosure, the resource processing device 1200 further includes an adjustment unit 1205.

The adjustment unit 1205 separately adjusts respective inventory quantities of the different resources included in the resource set according to the resource set corresponding to the itinerary event that is determined by the user and included in the payment request when receiving the payment request sent by the user.

In another embodiment provided by the present disclosure, the adjustment unit 1205 separately adjusting the respective inventory quantities of the different resources included in the resource set includes:

determining resource providers of the different resources included in the resource set; and

separately sending respective inventory adjustment information to the resource providers of the different resources, to cause the resource providers to adjust the respective inventory quantities of the resources included in the respective inventory adjustment information when receiving the respective inventory adjustment information.

In another embodiment provided by the present disclosure, the resource processing device 1200 further includes a prompting unit 1206.

The prompting unit 1206 sends a prompt message in response to that an inventory quantity of a resource is less than a defined threshold, the prompt message being used for reminding a supplement of the resource.

It should be noted that the resource processing device provided by the embodiments of the present disclosure may be applied to a resource sharing server, and the resource processing device may be implemented in a form of software, or may be implemented in a form of hardware, which is not specifically limited herein. A resource provider refines resources according to a degree of granularity of itinerary sub-events, so that a resource processing device can combine resources included in product information when receiving the product information published by different resource providers, so as to ensure that a user can clearly understand various resources included in a resource set after obtaining resource set. This improve the personalization and refinement of network services provided by a resource sharing server, enhances the user experience about the network services, and effectively changes the efficiency of flow of resources provided by the resource sharing server.

### Tenth Embodiment

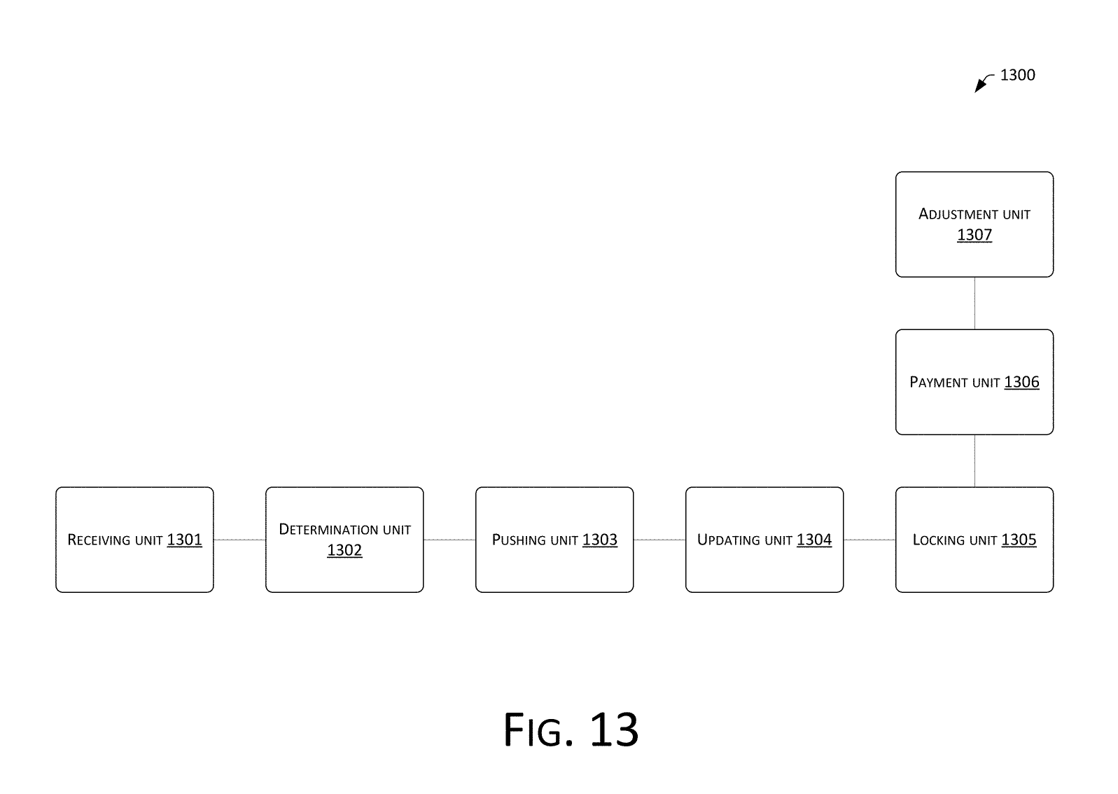

FIG. 13 is a schematic structural diagram of a resource processing device according to an embodiment of the present disclosure. The resource processing device 1300 includes: a receiving unit 1301, a determination unit 1302, and a pushing unit 1303, wherein:

the receiving unit 1301 receives a search request sent by a user, the search request including an itinerary event to be searched for;

the determination unit 1302 determines product information including the itinerary event based on the itinerary event, the product information including a correspondence relationship between resources used by itinerary sub-events in the itinerary event and the itinerary sub-events; and

the pushing unit 1303 pushes the product information to the user.

In another embodiment provided by the present disclosure, the resource processing device 1300 further includes an update unit 1304, wherein:

the updating unit 1304 receives a resource change request sent by the user, the resource change request including a resource identifier; determines a type and an attribute value of a usage attribute of a resource corresponding to the resource identifier; and searches a shared resource library for a resource with the same type and a different attribute value of the usage attribute, and pushes a resource that is found to the user, wherein the shared resource library includes multiple resources that are provided by different resource providers and demarcated by usage attributes of the resources.

In another embodiment provided by the present disclosure, the updating unit 1304 receives a resource change request sent by the user, the resource change request including an itinerary sub-event corresponding to a resource to be changed; calculates a time interval for completing the itinerary sub-event according to a time attribute of the itinerary sub-event; and finds another resource satisfying the time interval and being different from the resource that has been pushed from the shared resource library, and pushes the other resource that is found to the user.

In another embodiment provided by the present disclosure, the resource processing device 1300 further includes a locking unit 1305, wherein:

the locking unit 1305 receives order information sent by the user, the order information including product information selected by the user, and the product information including a correspondence relationship between at least one itinerary sub-event in the itinerary event selected by the user and resource(s) needed by the itinerary sub-event; and locks the resource(s) included in the product information according to the product information.

In another embodiment provided by the present disclosure, the resource processing device 1300 further includes a payment unit 1306, wherein:

the payment unit 1306 receives first payment information sent by the user, the first payment information being used for making a payment for the product information selected by the user; determines a resource provider that provides each resource in the product information and respective second payment information of each resource in the product information according to the product information, a sum of the respective second payment information of each resource being equal to the first payment information; and separately sends respective payment data to the resource provider corresponding to each resource according to the respective second payment information of each resource.

In another embodiment provided by the present disclosure, the resource processing device 1300 further includes an adjustment unit 1307, wherein:

the adjustment unit 1307 separately adjusts, according to product information included in payment information, a respective inventory quantity of each resource included in the product information in response to receiving the payment information sent by the user.

In another embodiment provided by the present disclosure, the adjustment unit 1307 separately adjusts the respective inventory quantity of each resource included in the product information includes:

determining a resource provider of each resource included in the product information; and

separately sending respective inventory adjustment information to the resource provider of each resource, to cause the resource provider to adjust an inventory quantity of the respective resource included in the respective inventory adjustment information when receiving the respective inventory adjustment information.

It should be noted that the resource processing device provided by the embodiments of the present disclosure may be applied to a resource sharing server, and the resource processing device may be implemented in a form of software, or may be implemented in a form of hardware, which is not specifically limited herein.

### Eleventh Embodiment

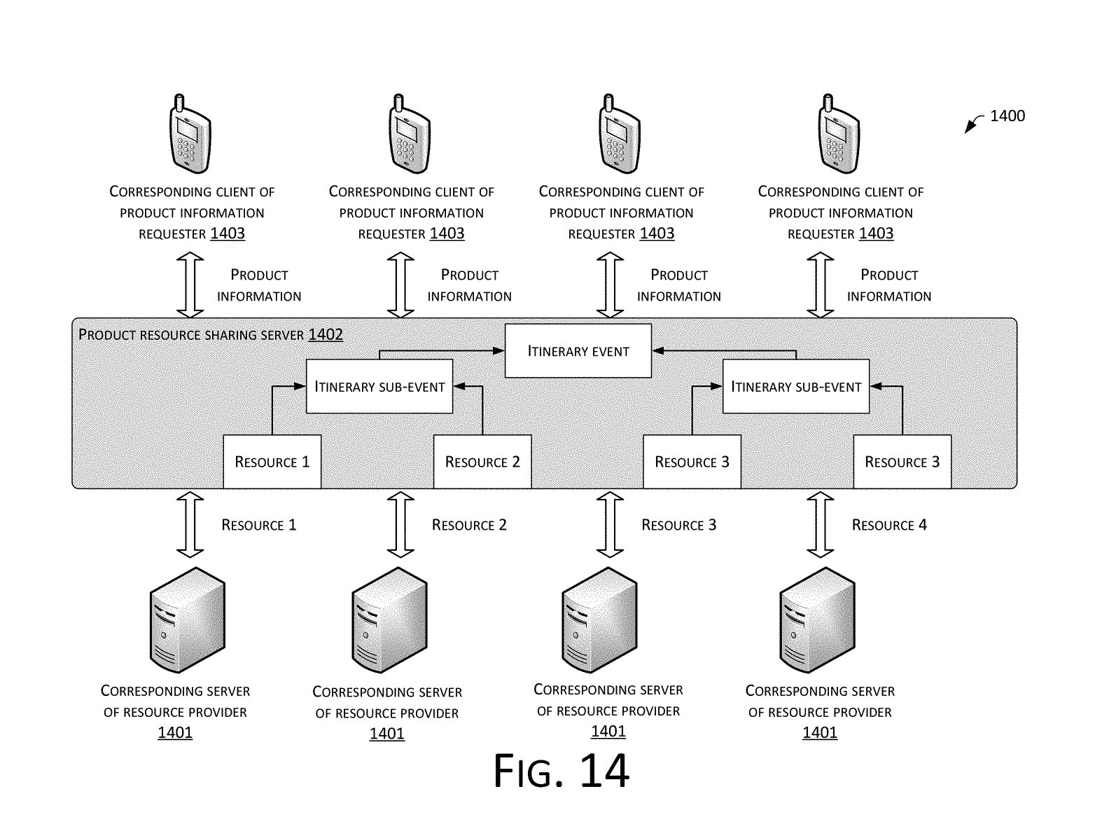

Based on the same inventive concept, FIG. 14 is a schematic structural diagram of a resource processing system 1400 according to an embodiment of the present disclosure. The resource processing system includes a corresponding server 1401 of at least one resource provider, a resource sharing server 1402, and a corresponding client 1403 of at least one resource requester.

The corresponding server 1401 of the at least one resource provider provides different pieces of product information, or provides resource(s) corresponding to an itinerary event in product information.

The resource sharing server 1402 may provide resources that are needed to the server corresponding to the resource provider, or may combine resources included in a plurality of pieces of product information when receiving the plurality of pieces of product information sent by servers corresponding to different resource providers, and publish thereof.

The corresponding client 1403 of the resource requester searches the resource sharing server 1402 for product information that is needed, and obtains the needed product information from product information that is found.

Specific implementation of the corresponding server 1401 of the at least one resource provider, the resource sharing server 1402, and the corresponding client 1403 of the at least one resource requester are the same as or similar to those described in the foregoing embodiments, and are not exhaustively described herein.

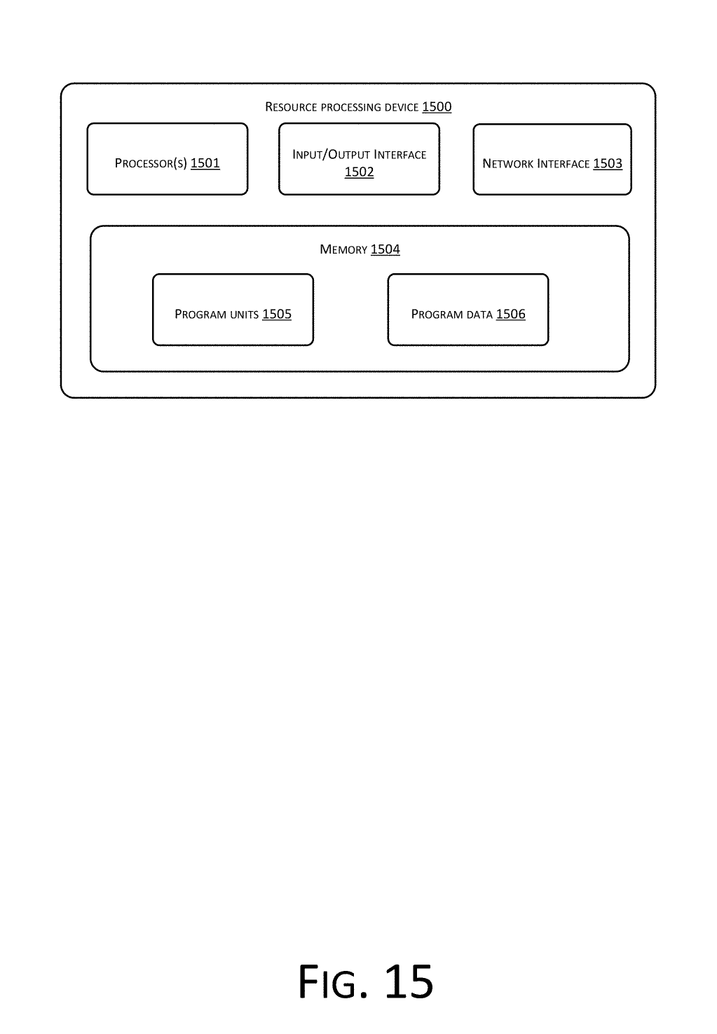

In the embodiments of the present disclosure, FIG. 15 shows an example resource processing device 1500 as described in FIGS. 9-13 in further detail. In implementations, the resource processing device 1500 may include one or more computing devices. In a typical configuration, a computing device includes one or more processors (CPUs), input/output interfaces, network interfaces, and memory. In implementations, the resource processing device 1500 may be a part of one or more computing devices, e.g., implemented or run by the one or more computing devices. In implementations, the one or more computing devices may be located in a single place or distributed among a plurality of network devices over a network. In implementations, the resource processing device 1500 may be included in a cloud computing system. By way of example and not limitation, the resource processing device 1500 may include one or more processors 1501, an input/output (I/O) interface 1502, a network interface 1503, and memory 1504.

The memory 1504 may include a form of computer readable media such as a volatile memory, a random access memory (RAM) and/or a non-volatile memory, for example, a read-only memory (ROM) or a flash RAM. The memory 1504 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 1504 may include program units 1505 and program data 1506. Depending on which device (e.g., any one of the devices 900-1300) that the resource processing device 1500 represents, the program units 1505 may include one or more of the units as described in the foregoing description and shown in FIGS. 9-13.

One skilled in the art should understand that the embodiments of the present invention can be provided as a method, a system, or a computer program product. Accordingly, the present invention may take a form of an entirely hardware embodiment, an entirely software embodiment, or a combination of software and hardware. Moreover, the invention can take a form of a computer program product embodied on one or more computer-usable storage media (including but not limited to a magnetic disk storage device, a CD-ROM, an optical storage device, etc.) that include computer usable program codes.

The present invention has been described with reference to flowcharts and/or block diagrams of methods, apparatus (system), and computer program products with reference to and according to the embodiments of the present invention. It should be understood that each process and/or block of the flowcharts and/or block diagrams, and combinations of processes and/or blocks of the flowcharts and/or block diagrams are implemented by computer program instructions. These computer program instructions can be provided to a general purpose computer, a special purpose computer, an embedded processor, or other programmable data processing device to produce a machine, to cause an execution of the instructions by a processor of a computer or other programmable data processing device to produce an apparatus used for implementing functions specified in one or more processes in the flowcharts and/or one or more blocks of the block diagrams.

These computer program instructions can also be stored in a computer readable storage device that can direct a computer or other programmable data processing device to operate in a specific way, such that the instructions stored in the computer readable storage device produce an article of manufacture including an instruction apparatus. The instruction apparatus implements functions specified in one or more processes in the flowcharts and/or one or more blocks of the block diagrams.

These computer program instructions can also be loaded onto a computer or other programmable data processing device, such that a series of operational operations are performed on a computer or other programmable device to produce computer-implemented processing, thereby the instructions that are executed on a computer or other programmable device provide operations for implementing functions one or more processes in the flowcharts and/or one or more blocks of the block diagrams.

It also needs to be noted that terms “containing”, “consisting of” or any other variations are intended to encompass a non-exclusive inclusion, such that a process, method, article, or device including a series of elements includes not only these elements, but also other elements that are not explicitly listed, or elements that are inherent to such process, method, article, or device. Without further limitation, an element defined by a phrase “comprising a . . . ” does not exclude a presence of additional equivalent elements in the process, method, article, or device including that element.

One skilled in the art should understand that the embodiments of the present disclosure can be provided as a method, system, or a computer program product. Thus, the present disclosure can take a form of an entirely hardware embodiment, an entirely software embodiment or an embodiment of a combination of software and hardware. Moreover, the present disclosure can take a form of a computer program product embodied on one or more computer-usable storage media (including but not limited to a magnetic disk storage device, a CD-ROM, an optical storage device, etc.) that include computer usable program codes.

The foregoing describes the embodiments of the present disclosure only, and is not intended to limit the present disclosure. Various changes and modifications can be made to the present disclosure by one skilled in the art. Any modifications, equivalents, improvements, etc., that are made within the spirit and scope of the present disclosure are intended to be included within the scope of the claims of the present disclosure.

The present disclosure can be further understood using the following clauses.

Clause 1: A resource processing method, which is applied to a first resource provider, comprising:

sending a resource search request to a resource sharing server, the resource search request including at least one itinerary sub-event in a first itinerary event;

receiving response information sent by the resource sharing server, the response information including at least one first resource included in product information that is published by a second resource provider and needed by the itinerary sub-event, and determining a correspondence relationship between the first resource and the itinerary sub-event that needs the first resource; and

publishing product information including the correspondence relationship to the resource sharing server.

Clause 2: The resource processing method according to Clause 1, wherein before sending the resource search request to the resource sharing server, the method further comprises:

determining the first itinerary event to be published and a second resource used by at least one itinerary sub-event in the first itinerary event; and

determining an itinerary sub-event with a missing resource in the first itinerary event according to the second resource.

Clause 3: The resource processing method according to Clause 2, wherein sending the resource search request to the resource sharing server comprises:

generating the resource search request according to the itinerary sub-event, the resource search request used for searching for resources needed by the itinerary sub-event; and

sending the resource search request to the resource sharing server.

Clause 4: The resource processing method according to Clause 1, wherein when the response information sent by the resource sharing server is received, the method further comprises:

selecting a third resource satisfying a requirement of the itinerary sub-event from the first resource that is received when receiving the first resource, the third resource being used in synchronization with a second itinerary event.

Clause 5: The resource processing method according to Clause 4, wherein the method further comprises:

determining a second resource that is used by the first itinerary event and owned by the first resource provider; and

combining the first resource/the third resource with the second resource to obtain a resource set corresponding to the first itinerary event.

Clause 6: The resource processing method according to any one of Clauses 1-5, wherein the method further comprises:

establishing a correspondence relationship between the product information and each resource according to resources used in the product information.

Clause 7: The resource processing method according to Clause 6, wherein the method further comprises:

receiving order information sent by the resource sharing server, the order information including the second resource;

adjusting an inventory quantity of the second resource according to the order information.

Clause 8: The resource processing method according to Clause 7, wherein the method further comprises:

sending a prompt message in response to detecting that the inventory quantity of the second resource is less than a defined threshold, the prompt message being used for reminding a supplement of the second resource.

Clause 9: A resource processing method comprising:

receiving a resource search request sent by a first resource provider, the resource search request including an itinerary event;

finding at least one resource satisfying a requirement of the itinerary event from a shared resource library, the shared resource library including a plurality of resources that are provided by different resource providers and demarcated according to usage attributes of the resources, and the usage attributes of the resources being determined based on itinerary sub-events included in different itinerary events; and

sending response information including the at least one resource that is found to the first resource provider.

Clause 10: The resource processing method according to Clause 9, wherein finding the at least one resource satisfying the requirement of the itinerary event from the shared resource library comprises:

determining a time attribute of an itinerary sub-event included in the resource search request based on the itinerary sub-event, the itinerary sub-event being an itinerary sub-event with a missing resource in the itinerary event; and

using a resource having an attribute value corresponding to a usage attribute satisfying the time attribute as the resource satisfying the requirement of the itinerary event.

Clause 11: A resource processing method, which is applied to a first resource provider, comprising:

determining a first itinerary event to be published;

determining an itinerary sub-event included in the first itinerary event according to the first itinerary event, and matching a corresponding resource for the itinerary sub-event;

generating product information to be published according to resources corresponding to different itinerary sub-events, the resources included in the product information being shared with a second itinerary event when satisfying a need of the second itinerary event published by a second resource provider;

publishing the product information, the product information comprising the first itinerary event and a resource set including resources used by each itinerary sub-event in the first itinerary event.

Clause 12: A resource processing method comprising:

receiving product information sent by different resource providers, the product information includes itinerary events and at least one resource used by a respective itinerary sub-event in the itinerary events;

combining, for a same itinerary event, different types of resources used by same/different itinerary sub-events in different pieces of the product information including the itinerary event to obtain a resource set used by the itinerary event; and

publishing the itinerary event and the resource set.

Clause 13: The resource processing method according to Clause 12, wherein combining, for the same itinerary event, the different types of resources used by the same/different itinerary sub-events in the different pieces of the product information including the itinerary event to obtain the resource set used by the itinerary event comprises:

determining, based on the same itinerary event, a plurality of pieces of the product information including the itinerary event; and

for a piece of the product information, performing the following:
determining a resource that is missing from an itinerary sub-event in the itinerary event in the piece of the product information;

finding the missing resource from other determined pieces of the product information;

combining the missing resource that is found with resources already included in the product information to obtain the resource set used by the itinerary event.

Clause 14: The resource processing method according to Clause 13, wherein determining the resource that is missing in the itinerary event in the piece of the product information comprises:

determining itinerary sub-events included in the itinerary event based on the itinerary event;

matching, for different itinerary sub-events, resources used for completing the itinerary sub-events according to the resources included in the piece of the product information;

determining, for an itinerary sub-event that has no matched resource, at least one type of resource used for completing the itinerary sub-event; and

taking the at least one determined type of resource as the resource missing from the itinerary event in the piece of the product information.

Clause 15: The resource processing method according to Clause 14, wherein matching, for the different itinerary sub-events, the resources used for completing the itinerary sub-events comprises:

determining respective time attributes of the itinerary sub-events for the different itinerary sub-events; and

using resources having respective attribute values corresponding to usage attributes satisfying the respective time attributes as the resources used for completing the itinerary sub-events.

Clause 16: The resource processing method according to Clause 13, wherein finding the missing resource from the other determined pieces of the product information comprises:

determining a time attribute of the itinerary sub-event corresponding to the missing resource; and

finding, from the other determined pieces of the product information, a resource having an attribute value corresponding to a usage attribute satisfying the time attribute as the missing resource.

Clause 17: The resource processing method according to Clause 12, wherein combining, for the same itinerary event, the different types of resources used by the different itinerary sub-events in the different pieces of the product information including the itinerary event to obtain the resource set used by the itinerary event comprises:

determining a plurality of pieces of product information including the itinerary event according to the same itinerary event;

determining a time attribute of each itinerary sub-event included in each of the plurality of pieces of the product information; and

combining different types of resources used by different itinerary sub-events in different pieces of the product information based on the time attribute to obtain the resource set used by the itinerary event.

Clause 18: The resource processing method according to any one of Clauses 12-17, wherein:

resources included in resource sets corresponding to a same itinerary event are identical; or

resources of a same type included in resource sets corresponding to different itinerary events are identical.

Clause 19: The resource processing method according to Clause 18, wherein the method further comprises:

receiving a payment request sent by the user, the payment request comprising a resource set corresponding to an itinerary event determined by the user;

determining a resource provider of each resource included in the resource set; and

sending respective payment information to different resource providers according to payment information of each resource included in the resource set.

Clause 20: The resource processing method according to Clause 19, wherein the method further comprises:

separately adjusting respective inventory quantities of different resources included in the resource set according to the resource set corresponding to the itinerary event determined by the user included in the payment request in response to receiving the payment request sent by the user.

Clause 21: The resource processing method according to Clause 20, wherein separately adjusting the respective inventory quantities of the different resources included in the resource set comprises:

determining resource providers of different resources included in the resource set;

separately sending respective inventory adjustment information to the resource providers of different resources, to cause the resource providers to adjust the respective inventory quantities of the resources included in the respective inventory adjustment information when receiving the respective inventory adjustment information.

Clause 22: The resource processing method according to Clause 20 or 21, wherein the method further comprises:

sending a prompt message in response to detecting that an inventory quantity of a resource is less than a defined threshold, the prompt message being used for reminding a supplement of the resource.

Clause 23: A resource processing method comprising:

receiving a search request sent by a user, the search request comprising an itinerary event to be searched for;

determining product information including the itinerary event according to the itinerary event, the product information comprising a correspondence relationship between a resource used by the itinerary sub-event in the itinerary event and the itinerary sub-event; and

pushing the product information to the user.

Clause 24: The resource processing method according to Clause 23, wherein the method further comprises:

receiving a resource change request sent by the user, the resource change request comprising a resource identifier;

determining a type of a resource corresponding to the resource identifier and an attribute value of a usage attribute;

finding resources having the same type and a different attribute value of the usage attribute from a shared resource library, and pushing the found resources to the user, the shared resource library comprising multiple resources that are provided by different resource providers and demarcated by usage attributes of the resources.

Clause 25: The resource processing method according to Clause 24, wherein the method further comprises:

receiving the resource change request sent by the user, the resource change request comprising an itinerary sub-event corresponding to a resource to be changed;

calculating a time interval for completing the itinerary sub-event according to a time attribute of the itinerary sub-event;

finding other resources that satisfy the time interval and different from a pushed resource from the shared resource library, and pushing the other resources that are found to the user.

Clause 26: The resource processing method according to any one of Clauses 23-25, wherein the method further comprises:

receiving order information sent by the user, the order information comprising product information selected by the user, and the product information comprising a correspondence relationship between at least one itinerary event of an itinerary event selected by the user and a resource need by the itinerary event;

locking the resource included in the product information according to the product information.

Clause 27: The resource processing method according to Clause 26, wherein the method further comprises:

receiving first payment information sent by the user, the first payment information being used for making a payment for the product information selected by the user;

determining, according to the product information, a respective resource provider that provides each resource in the product information and respective second payment information of each resource in the product information, a sum of the respective second payment information of each resource being equal to the first payment information;

separately sending respective payment data to the respective resource provider corresponding to each resource according to the respective second payment information of each resource.

Clause 28: The resource processing method according to Clause 27, wherein the method further comprises:

separately adjusting an inventory quantity of each resource included in the product information according to the product information included in the payment information upon receiving the payment information transmitted by the user.

Clause 29: The resource processing method according to Clause 28, wherein separately adjusting the inventory quantity of each resource included in the product information comprises:

determining a respective resource provider of each resource included in the product information;

separately sending respective inventory adjustment information to the respective resource provider of each resource, to cause the respective resource provider to adjust the inventory quantity of the respective resource included in the respective inventory adjustment information when receiving the respective inventory adjustment information.

Clause 30: A resource processing device, which is applied to a first resource provider, comprising:

a sending unit that sends a resource search request to a resource sharing server, the resource search request including at least one itinerary sub-event in a first itinerary event;

a receiving unit that receives response information sent by the resource sharing server, the response information including at least one first resource included in product information that is published by a second resource provider and needed by the itinerary sub-event, and determines a correspondence relationship between the first resource and the itinerary sub-event that needs the first resource; and

a publishing unit that publishes product information including the correspondence relationship to the resource sharing server.

Clause 31: The resource processing device according to Clause 30, wherein the resource processing device further comprises a determination unit, wherein:

the determination unit determines the first itinerary event to be published and a second resource used by at least one itinerary sub-event in the first itinerary event before the resource search request is sent to the resource sharing server; and determines an itinerary sub-event with a missing resource in the first itinerary event according to the second resource.

Clause 32: The resource processing device according to Clause 31, wherein the sending unit sending the resource search request to the resource sharing server comprises:

generating the resource search request according to the itinerary sub-event, the resource search request used for searching for resources needed by the itinerary sub-event; and

sending the resource search request to the resource sharing server.

Clause 33: The resource processing device according to claim 30, wherein the device further comprises a screening unit, wherein:

when the response information sent by the resource sharing server is received, the screening unit selects a third resource satisfying a requirement of the itinerary sub-event from the first resource that is received when receiving the first resource the third resource being used in synchronization with a second itinerary event.

Clause 34: The resource processing device according to Clause 33, wherein the resource processing device further comprises a combination unit, wherein:

the combination unit determines a second resource that is used by the first itinerary event and owned by the first resource provider; and combines the first resource/the third resource with the second resource to obtain a resource set corresponding to the first itinerary event.

Clause 35: The resource processing device according to any one of Clauses 30-34, wherein the resource processing device further comprises a storage unit, wherein:

the storage unit establishes a correspondence relationship between the product information and each resource according to resources used in the product information.

Clause 36: The resource processing device according to Clause 35, wherein the resource processing device further comprises an inventory adjustment unit, wherein:

the inventory adjustment unit receives order information sent by the resource sharing server, the order information including the second resource; and adjusts an inventory quantity of the second resource according to the order information.

Clause 37: The resource processing device according to Clause 36, wherein the resource processing device further comprises a prompting unit, wherein:

the prompting unit sends a prompt message in response to detecting that the inventory quantity of the second resource is less than a defined threshold, the prompt message being used for reminding a supplement of the second resource.

Clause 38: A resource processing device comprising:

a receiving unit that receives a resource search request sent by a first resource provider, the resource search request including an itinerary event;

a searching unit that finds at least one resource satisfying a requirement of the itinerary event from a shared resource library, the shared resource library including a plurality of resources that are provided by different resource providers and demarcated according to usage attributes of the resources, and the usage attributes of the resources being determined based on different itinerary sub-events included in the itinerary event; and

a sending unit that sends response information including the at least one resource that is found to the first resource provider.

Clause 39: The resource processing device according to Clause 38, wherein the searching unit finding the at least one resource satisfying the requirement of the itinerary event from the shared resource library comprises:

determining a time attribute of an itinerary sub-event based on the itinerary sub-event included in the resource search request, the itinerary sub-event being an itinerary sub-event with a missing resource in the itinerary event; and

using a resource having an attribute value corresponding to a usage attribute satisfying the time attribute as the resource satisfying the requirement of the itinerary event.

Clause 40: A resource processing device, which is applied to a first resource provider, comprising:

a determination unit that determines a first itinerary event to be published, determines an itinerary sub-event included in the first itinerary event according to the first itinerary event, and matches a corresponding resource for the itinerary sub-event;

a generation unit that generates product information to be published according to resources corresponding to different itinerary sub-events, the resources included in the product information being shared with a second itinerary event when satisfying a need of the second itinerary event published by a second resource provider;

a publishing unit that publishes the product information, the product information comprising the first itinerary event and a resource set including resources used by each itinerary sub-event in the first itinerary event.

Clause 41: A resource processing device comprising:

a receiving unit that receives product information sent by different resource providers, the product information includes itinerary events and at least one resource used by a respective itinerary sub-event in the itinerary events;

a combination unit that combines, for a same itinerary event, different types of resources used by same/different itinerary sub-events in different pieces of the product information including the itinerary event to obtain a resource set used by the itinerary event; and

a publishing unit that publishes the itinerary event and the resource set.

Clause 42: The resource processing device according to Clause 41, wherein the combination unit combining, for the same itinerary event, the different types of resources used by the same/different itinerary sub-events in the different pieces of the product information including the itinerary event to obtain the resource set used by the itinerary event comprises:

determining, based on the same itinerary event, a plurality of pieces of the product information including the itinerary event; and

for a piece of the product information, performing the following:

determining a resource that is missing from an itinerary sub-event in the itinerary event in the piece of the product information;

finding the missing resource from other determined pieces of the product information;

combining the missing resource that is found with resources already included in the product information to obtain the resource set used by the itinerary event.

Clause 43: The resource processing device according to Clause 42, wherein the combination unit determining the resource that is missing in the itinerary event in the piece of the product information comprises:

determining itinerary sub-events included in the itinerary event based on the itinerary event;

matching, for different itinerary sub-events, resources used for completing the itinerary sub-events according to the resources included in the piece of the product information;

determining, for an itinerary sub-event that has no matched resource, at least one type of resource used for completing the itinerary sub-event; and

taking the at least one determined type of resource as the resource missing from the itinerary event in the piece of the product information.

Clause 44: The resource processing device according to Clause 43, wherein the combination unit matching, for the different itinerary sub-events, the resources used for completing the itinerary sub-events comprises:

determining respective time attributes of the itinerary sub-events for the different itinerary sub-events; and

using resources having respective attribute values corresponding to usage attributes satisfying the respective time attributes as the resources used for completing the itinerary sub-events.

Clause 45: The resource processing device according to Clause 42, wherein the combination unit finding the missing resource from the other determined pieces of the product information comprises:

determining a time attribute of the itinerary sub-event corresponding to the missing resource; and

finding, from the other determined pieces of the product information, a resource having an attribute value corresponding to a usage attribute satisfying the time attribute as the missing resource.

Clause 46: The resource processing device according to Clause 41, wherein the combination unit combining, for the same itinerary event, the different types of resources used by the different itinerary sub-events in the different pieces of the product information including the itinerary event to obtain the resource set used by the itinerary event comprises:

determining a plurality of pieces of product information including the itinerary event according to the same itinerary event;

determining a time attribute of each itinerary sub-event included in each of the plurality of pieces of the product information; and

combining different types of resources used by different itinerary sub-events in different pieces of the product information based on the time attribute to obtain the resource set used by the itinerary event.

Clause 47: The resource processing device according to any one of Clauses 41-46, wherein:

resources included in resource sets corresponding to a same itinerary event are identical; or

resources of a same type included in resource sets corresponding to different itinerary events are identical.

Clause 48: The resource processing device according to Clause 47, wherein the resource processing device further comprises a payment unit, wherein:

the payment unit receives a payment request sent by the user, the payment request comprising a resource set corresponding to an itinerary event determined by the user; determines a resource provider of each resource included in the resource set; and sends respective payment information to different resource providers according to payment information of each resource included in the resource set.

Clause 49: The resource processing device according to Clause 48, wherein the resource processing device further comprises an adjustment unit, wherein:

the adjustment unit separately adjusts respective inventory quantities of different resources included in the resource set according to the resource set corresponding to the itinerary event determined by the user included in the payment request in response to receiving the payment request sent by the user.

Clause 50: The resource processing device according to Clause 49, wherein the adjustment unit separately adjusting the respective inventory quantities of the different resources included in the resource set comprises:

determining resource providers of different resources included in the resource set;

separately sending respective inventory adjustment information to the resource providers of different resources, to cause the resource providers to adjust the respective inventory quantities of the resources included in the respective inventory adjustment information when receiving the respective inventory adjustment information.

Clause 51: The resource processing device according to Clause 49 or 50, wherein the resource processing device further comprises a prompting unit, wherein:

the prompting unit sends a prompt message in response to detecting that an inventory quantity of a resource is less than a defined threshold, the prompt message being used for reminding a supplement of the resource.

Clause 52: A resource processing device comprising:

a receiving unit that receives a search request sent by a user, the search request comprising an itinerary event to be searched for;

a determination unit that determines product information including the itinerary event according to the itinerary event, the product information comprising a correspondence relationship between a resource used by the itinerary sub-event in the itinerary event and the itinerary sub-event; and

a pushing unit that pushes the product information to the user.

Clause 53: The resource processing device according to Clause 52, wherein the resource processing device further comprises an updating unit, wherein:

the updating unit receives a resource change request sent by the user, the resource change request comprising a resource identifier; determines a type of a resource corresponding to the resource identifier and an attribute value of a usage attribute; and finds resources having the same type and a different attribute value of the usage attribute from a shared resource library, and pushes the found resources to the user, the shared resource library comprising multiple resources that are provided by different resource providers and demarcated by usage attributes of the resources.

Clause 54: The resource processing device according to Clause 52, wherein the resource processing device further comprises an updating unit, wherein:

the updating unit receives a resource change request sent by the user, the resource change request comprising an itinerary sub-event corresponding to a resource to be changed; calculates a time interval for completing the itinerary sub-event according to a time attribute of the itinerary sub-event; and finds other resources that satisfy the time interval and different from a pushed resource from the shared resource library, and pushes the other resources that are found to the user.

Clause 55: The resource processing device according to any one of Clauses 52-54, wherein the resource processing device further comprises a locking unit, wherein:

the locking unit receives order information sent by the user, the order information comprising product information selected by the user, and the product information comprising a correspondence relationship between at least one itinerary event of an itinerary event selected by the user and a resource need by the itinerary event; and locks the resource included in the product information according to the product information.

Clause 56: The resource processing device according to Clause 55, wherein the resource processing device further comprises a payment unit, wherein:

the payment unit receives first payment information sent by the user, the first payment information being used for making a payment for the product information selected by the user; determines, according to the product information, a respective resource provider that provides each resource in the product information and respective second payment information of each resource in the product information, a sum of the respective second payment information of each resource being equal to the first payment information; and separately sends respective payment data to the respective resource provider corresponding to each resource according to the respective second payment information of each resource.

Clause 57: The resource processing device according to Clause 56, wherein the resource processing device further comprises an adjustment unit, wherein:

the adjustment unit separately adjusts an inventory quantity of each resource included in the product information according to the product information included in the payment information upon receiving the payment information sent by the user.

Clause 58: The resource processing device according to Clause 57, wherein the adjustment unit separately adjusting the inventory quantity of each resource included in the product information comprises:

determining a respective resource provider of each resource included in the product information;

separately sending respective inventory adjustment information to the respective resource provider of each resource, to cause the respective resource provider to adjust the inventory quantity of the respective resource included in the respective inventory adjustment information when receiving the respective inventory adjustment information.

What is claimed is:

1. A method implemented by a first resource provider comprising one or more computing devices, the method comprising:
sending a resource search request to a resource sharing server, the resource search request including one or more itinerary sub-events in a first itinerary event;
receiving response information sent by the resource sharing server, the response information including at least one first resource included in product information that is published by a second resource provider and needed by at least one itinerary sub-event;
determining a correspondence relationship between the at least one first resource and the at least one itinerary sub-event that needs the at least one first resource; and
publishing product information including the correspondence relationship to the resource sharing server.

2. The method according to claim 1, further comprising:
determining a second resource used by the at least one itinerary sub-event in the first itinerary event before sending the resource search request to the resource sharing server; and
determining an itinerary sub-event with a missing resource in the first itinerary event according to the second resource.

3. The method according to claim 2, wherein sending the resource search request to the resource sharing server comprises:
generating the resource search request according to the itinerary sub-event with the missing resource, the resource search request used for searching for resources needed by the itinerary sub-event with the missing resource; and
sending the resource search request to the resource sharing server.

4. The method according to claim 1, further comprising:
selecting a third resource satisfying a requirement of the at least one itinerary sub-event from the at least one first resource when the response information sent by the resource sharing server is received, the third resource being used in synchronization with a second itinerary event.

5. The method according to claim 4, further comprising:
determining a second resource that is used by the first itinerary event and owned by the first resource provider; and
combining one or more of the at least one first resource and the third resource with the second resource to obtain a resource set corresponding to the first itinerary event.

6. The method according to any claim 1, further comprising:
establishing a respective correspondence relationship between the product information and each resource according to resources used in the product information.

7. The method according to claim 1, further comprising:
receiving order information sent by the resource sharing server, the order information including a second resource used by the first itinerary event;
adjusting an inventory quantity of the second resource according to the order information.

8. The method according to claim 7, further comprising:
sending a prompt message in response to detecting that the inventory quantity of the second resource is less than a defined threshold, the prompt message being used for reminding a supplement of the second resource.

9. A device comprising:
one or more processors;
memory;
a receiving unit stored in the memory and executable by the one or more processors to receive a resource search request sent by a first resource provider, the resource search request including an itinerary event;
a searching unit stored in the memory and executable by the one or more processors to find at least one resource satisfying a requirement of the itinerary event from a shared resource library, the shared resource library including a plurality of resources that are provided by different resource providers and demarcated according to usage attributes of the resources, and the usage attributes of the resources being determined based on itinerary sub-events included in different itinerary events; and
a sending unit stored in the memory and executable by the one or more processors to send response information including the at least one resource that is found to the first resource provider.

10. The device according to claim 9, wherein the searching unit finding the at least one resource satisfying the requirement of the itinerary event from the shared resource library comprises:
determining a time attribute of an itinerary sub-event included in the resource search request based on the itinerary sub-event, the itinerary sub-event being an itinerary sub-event with a missing resource in the itinerary event; and
using a resource having an attribute value corresponding to a usage attribute satisfying the time attribute as the resource satisfying the requirement of the itinerary event.

11. One or more computer readable media storing executable instructions that, when executed by one or more processors, cause the one or more processors to perform acts comprising:
receiving product information sent by different resource providers, the product information includes itinerary events and at least one resource used by a respective itinerary sub-event in the itinerary events;
combining, for a same itinerary event, different types of resources used by same and/or different itinerary sub-events in different pieces of the product information including the itinerary event to obtain a resource set used by the itinerary event; and
publishing the itinerary event and the resource set.

12. The one or more computer readable media according to claim 11, wherein combining, for the same itinerary event, the different types of resources used by the same/different itinerary sub-events in the different pieces of the product information including the itinerary event to obtain the resource set used by the itinerary event comprises:
determining, based on the same itinerary event, a plurality of pieces of the product information including the itinerary event; and
for a piece of the product information, performing the following:
determining a resource that is missing from an itinerary sub-event in the itinerary event in the piece of the product information;
finding the missing resource from other determined pieces of the product information;
combining the missing resource that is found with resources already included in the product information to obtain the resource set used by the itinerary event.

13. The one or more computer readable media according to claim 12, wherein determining the resource that is missing in the itinerary event in the piece of the product information comprises:
determining itinerary sub-events included in the itinerary event based on the itinerary event;
matching, for different itinerary sub-events, resources used for completing the itinerary sub-events according to the resources included in the piece of the product information;
determining, for an itinerary sub-event that has no matched resource, at least one type of resource used for completing the itinerary sub-event; and
taking the at least one determined type of resource as the resource missing from the itinerary event in the piece of the product information.

14. The one or more computer readable media according to claim 13, wherein matching, for the different itinerary sub-events, the resources used for completing the itinerary sub-events comprises:
determining respective time attributes of the itinerary sub-events for the different itinerary sub-events; and
using resources having respective attribute values corresponding to usage attributes satisfying the respective time attributes as the resources used for completing the itinerary sub-events.

15. The one or more computer readable media according to claim 12, wherein finding the missing resource from the other determined pieces of the product information comprises:
determining a time attribute of the itinerary sub-event corresponding to the missing resource; and
finding, from the other determined pieces of the product information, a resource having an attribute value corresponding to a usage attribute satisfying the time attribute as the missing resource.

16. The one or more computer readable media according to claim 11, wherein combining, for the same itinerary event, the different types of resources used by the different itinerary sub-events in the different pieces of the product information including the itinerary event to obtain the resource set used by the itinerary event comprises:
determining a plurality of pieces of product information including the itinerary event according to the same itinerary event;
determining a time attribute of each itinerary sub-event included in each of the plurality of pieces of the product information; and
combining different types of resources used by different itinerary sub-events in different pieces of the product information based on the time attribute to obtain the resource set used by the itinerary event.

17. The one or more computer readable media according to claim 11, wherein:
resources included in resource sets corresponding to a same itinerary event are identical; or
resources of a same type included in resource sets corresponding to different itinerary events are identical.

18. The one or more computer readable media according to claim 17, wherein the acts further comprise:
receiving a payment request sent by the user, the payment request comprising a resource set corresponding to an itinerary event determined by the user;
determining a resource provider of each resource included in the resource set; and
sending respective payment information to different resource providers according to payment information of each resource included in the resource set.

19. The one or more computer readable media according to claim 18, wherein the acts further comprise:
separately adjusting respective inventory quantities of different resources included in the resource set according to the resource set corresponding to the itinerary event determined by the user included in the payment request in response to receiving the payment request sent by the user.

20. The one or more computer readable media according to claim 19, wherein separately adjusting the respective inventory quantities of the different resources included in the resource set comprises:
determining resource providers of different resources included in the resource set;
separately sending respective inventory adjustment information to the resource providers of different resources, to cause the resource providers to adjust the respective inventory quantities of the resources included in the respective inventory adjustment information when receiving the respective inventory adjustment information.
